(19) United States
(12) Patent Application Publication
(10) Pub. No.: US 2023/0271140 A1
(43) Pub. Date: Aug. 31, 2023

(54) METHOD FOR WASHING HOLLOW FIBER MEMBRANE MODULE

(71) Applicant: ASAHI KASEI KABUSHIKI KAISHA, Tokyo (JP)

(72) Inventors: Daisuke OKAMURA, Tokyo (JP); Yutaka GOJO, Tokyo (JP); Yuji KIMURA, Tokyo (JP)

(73) Assignee: ASAHI KASEI KABUSHIKI KAISHA, Tokyo (JP)

(21) Appl. No.: 18/143,803

(22) Filed: May 5, 2023

Related U.S. Application Data
(62) Division of application No. 18/035,197, filed on Jan. 1, 0001.

(30) Foreign Application Priority Data
Nov. 30, 2020 (JP) 2020-198493
Jan. 22, 2021 (JP) 2021-008651

(51) Int. Cl. B01D 65/02; B01D 63/04; B01D 63/02; B01D 61/14; C02F 1/44

(52) U.S. Cl. CPC B01D 65/02; B01D 63/04; B01D 63/0233; B01D 61/145; C02F 1/444; B01D 2321/04; B01D 2321/02; B01D 2321/185; C02F 2303/16

(57) ABSTRACT

Provided is a method for washing a hollow fiber membrane module which comprises a hollow fiber membrane for filtering raw water containing a suspended component, said method comprising, in the following order, a first washing step for removing a suspended component that is accumulated on the hollow fiber membrane and a second washing step for carrying out an air scrubbing process in which gas is caused to pass through at least to the raw water side of the hollow fiber membrane, wherein, out of water that existed in the hollow fiber membrane module before washing, water in an amount corresponding to not less than 50 vol % of the capacity of the hollow fiber membrane module is removed in the first washing step.

### CLAIM FOR PRIORITY

This application is a Divisional of Ser. No. 18/035,197 filed May 3, 2023, which is a National Stage of PCT/JP2021/043885 filed Nov. 30, 2021, and claims the priority benefit of Japanese applications JP 2020-198493 filed Nov. 30, 2020, and JP 2021-008651 filed Jan. 22, 2021, the contents of which are expressly incorporated by reference herein in their entireties.

### FIELD

The present invention relates to a method for cleaning a hollow fiber membrane module used for filtering raw water containing a suspended component.

### BACKGROUND

Membrane filtration is used in processes of treating raw water such as river water, lake water, underground streams, raw water for industrial use, sewage, secondary sewage treatment water, industrial wastewater, household wastewater, human waste, and sea water, which are suspension fluids.

Membrane filtration methods are advantageous in that:
(1) clarification level of the resulting water quality is high and stable, and therefore safety of the obtained water is high;
(2) installation space for the filtration apparatus is small; and
(3) automatic operation is easy.

Hollow fiber ultrafiltration membranes and microfiltration membranes (average pore size in the range of several nm to several hundred nm) are mainly used in clarification operations by membrane filtration.

Porous organic membranes composed of synthetic resins are often used as hollow fiber membranes. For example, PTL 1 discloses a polyvinylidene fluoride-based porous membrane and use thereof as hollow fiber membranes.

When raw water as described above is subjected to membrane filtration, suspended components (organic and inorganic substances) contained in the raw water are blocked by a filtration membrane and removed. When such raw water filtration is continued, the suspended components in the raw water accumulate on the filtration membrane, concentration polarization, formation of a cake layer, or clogging of the membrane occurs. Consequently, as filtration continues, the permeable water flow rate decreases.

Therefore, in the membrane filtration treatment of raw water, membranes are periodically cleaned.

As a method for cleaning a filtration hollow fiber membrane module, for example, reverse-flow cleaning (backwashing), in which a liquid is flowed from a filtered water side to a raw water side of the hollow fiber membranes, is known. Alternatively, air scrubbing, in which a compressed gas is supplied from the bottom to the top of the hollow fiber membrane module that is filled with a liquid to move the hollow fibers by shaking to remove the suspended components accumulated between the hollow fibers, is known.

PTL 2 discloses a cleaning method in which air bubble nozzles are arranged on the side or below hollow fiber membranes in a module casing, and backwashing and gas jetting from the nozzles are carried out simultaneously.

PTL 3 discloses a cleaning method in which a gas is introduced from the raw water side of a module and, at the same time, a gas or liquid is passed from a filtered water side to a raw water side of the hollow fiber membranes.

### CITATION LIST

### Patent Literature

[PTL 1] Japanese Unexamined Patent Publication (Kokai) No. 2011-168741
[PTL 2] Japanese Unexamined Patent Publication (Kokai) No. 60-19002
[PTL 3] Japanese Patent Publication No. 3948593

### SUMMARY

### Technical Problem

The techniques of PTL 2 and 3 are effective methods for removing a suspended component accumulated on hollow fiber membranes, and contribute to stable operation of raw water filtration using hollow fiber membrane modules.

However, conventional cleaning methods typified by PTL 2 and 3 remain insufficient in cleaning efficiency from the viewpoint of process design for long-term use of the hollow fiber membranes.

Specifically, assuming the lifespan of a hollow fiber membrane module to be 10 years, the scale of a filtration plant is set based on the filtration performance of the hollow fiber membrane module after 10 years. For example, if the performance of a hollow fiber membrane module after years is 60% of the initial performance, the required filtration amount is allocated at the filtration performance of 60% to determine the number of hollow fiber membrane modules. In this case, for the initial performance of the filtration plant, the amount required is 167% (=100/0.6), and the equipment design corresponding to 67% becomes excessive.

If the cleaning efficiency can be improved to increase the performance of the hollow fiber membrane module after 10 years to, for example, 90% of the initial performance, the initial performance of the filtration plant can be reduced to a required amount of 111% (=100/0.9), and the excess in equipment design can be reduced to 11%.

An object of the present invention is to provide a method for cleaning a hollow fiber membrane module in which the deterioration of filtration performance is remarkably suppressed when the hollow fiber membrane module is used for a long period of time.

When a porous membrane is used in a filtration operation accompanied by a cleaning step, there is a problem that filtration performance decreases over time or the lifespan of the hollow fiber membrane module is affected.

Therefore, another object of the present invention is to provide a hollow fiber membrane module in which, when a filtration operation using porous hollow fiber membranes is accompanied by a cleaning step, cleaning efficiency is excellent, deterioration of filtration performance over time is suppressed, and lifespan of the hollow fiber membranes and the hollow fiber membrane module comprising the same are not impaired.

### Solution to Problem

The present invention is as follows.

<<Aspect 1>> A method for cleaning a hollow fiber membrane module which comprises a hollow fiber membrane for filtering raw water containing a suspended component, comprising in the following order:
a first cleaning step of removing the suspended component accumulated on the hollow fiber membrane; and
a second cleaning step of carrying out an air scrubbing treatment by passing a gas through at least a raw water side of the hollow fiber membrane, wherein
with respect to a capacity of the hollow fiber membrane, 50% by volume or greater of water present in the hollow fiber membrane module before cleaning is removed in the first cleaning step.

<<Aspect 2>> The method for cleaning a hollow fiber membrane module according to Aspect 1, wherein the first cleaning step is a step of carrying out at least one treatment of the following (A1) to (A3):
(A1) a reverse-flow cleaning treatment by passing water from a filtered water side to a raw water side of the hollow fiber membrane;
(A2) a flushing treatment by passing water through a raw water side of the hollow fiber membrane; and
(A3) a draining treatment by discharging a liquid within the hollow fiber membrane module.

<<Aspect 3>> The method for cleaning a hollow fiber membrane module according to Aspect 1 or 2, wherein 7% by mass or greater of a suspended component accumulated in the hollow fiber membrane is removed in the first cleaning step.

<<Aspect 4>> The method for cleaning a hollow fiber membrane module according to Aspect 1 or 2, wherein the second cleaning step is a step of carrying out any of the following (B1) to (B3):
(B1) a step of carrying out only an air scrubbing treatment by passing a gas through a raw water side of the hollow fiber membrane;
(B2) a step of simultaneously carrying out an air scrubbing treatment by passing a gas through a raw water side of the hollow fiber membrane and a reverse-flow cleaning treatment by passing water from a filtered water side to a raw water side of the hollow fiber membrane; and
(B3) a step of simultaneously carrying out an air scrubbing treatment by passing a gas through a raw water side of the hollow fiber membrane and a flushing treatment by passing water through a raw water side of the hollow fiber membrane.

<<Aspect 5>> The method for cleaning a hollow fiber membrane module according to any one of Aspects 1 to 4, further comprising
a third cleaning step of discharging the suspended component to an exterior portion of the hollow fiber membrane module after the first cleaning step and the second cleaning step.

<<Aspect 6>> The method for cleaning a hollow fiber membrane module according to Aspect 5, wherein the third cleaning step is a step of carrying out at least one treatment of the following (C1) and (C2):
(C1) a flushing treatment by passing water through a raw water side of the hollow fiber membrane; and
(C2) a reverse-flow cleaning treatment by passing water from a filtered water side to a raw water side of the hollow fiber membrane.

<<Aspect 7>> The method for cleaning a hollow fiber membrane module according to any one of Aspects 1 to 6, wherein
the hollow fiber membrane module comprises
   a hollow fiber membrane bundle composed of a plurality of hollow fiber membranes;
   a housing in which the hollow fiber membrane bundle is housed;
   an adhesive fixing portion by which both ends of the hollow fiber membrane bundle are adhesively fixed to the housing;
   an inlet for communicating between an exterior portion of the hollow fiber membrane module and an exterior space of the hollow fiber membranes;
   a filtered water port for communicating between an exterior portion of the hollow fiber membrane module and interior spaces of the hollow fiber membranes; and
   a cleaning outlet for communicating between an exterior portion of the hollow fiber membrane module and an exterior space of the hollow fiber membranes.

<<Aspect 8>> The method for cleaning a hollow fiber membrane module according to Aspect 7, wherein the hollow fiber membranes are microfiltration (MF) membranes or ultrafiltration (UF) membranes.

<<Aspect 9>> The method for cleaning a hollow fiber membrane module according to Aspect 7 or 8, wherein
the adhesive fixing portion comprises
   a first adhesive fixing layer for adhesively fixing hollow fiber membranes to each other and the hollow fiber membrane bundle to an interior wall of the housing via a resin material at one end of the hollow fiber membranes; and
   a second adhesive fixing layer for adhesively fixing the hollow fiber membranes to each other and the hollow fiber membrane bundle to an interior wall of the housing via a resin material at the other end of the hollow fiber membranes.

<<Aspect 10>> A hollow fiber membrane module comprising
a hollow fiber membrane bundle composed of a plurality of hollow fiber membranes;
a housing in which the hollow fiber membrane bundle is housed; and
an adhesive fixing portion by which both ends of the hollow fiber membrane bundle are adhesively fixed to the housing, wherein
the hollow fiber membranes are microfiltration (MF) membranes or ultrafiltration (UF) membranes,
the adhesive fixing portion comprises
   a first adhesive fixing layer for adhesively fixing hollow fiber membranes to each other and the hollow fiber membrane bundle to an interior wall of the housing via a resin material at one end of the hollow fiber membranes; and
   a second adhesive fixing layer for adhesively fixing the hollow fiber membranes to each other and the hollow fiber membrane bundle to an interior wall of the housing via a resin material at the other end of the hollow fiber membranes,
the hollow fiber membrane module comprises
   an inlet for communicating between an exterior portion of the hollow fiber membrane module and a space outside the hollow fiber membranes;
   a filtered water port for communicating between an exterior portion of the hollow fiber membrane module and spaces inside the hollow fiber membranes; and
   a cleaning outlet for communicating between an exterior portion of the hollow fiber membrane module and a space outside the hollow fiber membranes, and
all of the following conditions (A), (B), and (C) are satisfied:
   (A) a packing rate of the hollow fiber membranes, which is expressed as a ratio of a total cross-sectional area of the hollow fiber membranes to an internal cross-sectional area of the housing, is 38% or less;
   (B) an outer diameter of the hollow fiber membranes is 1.1 mm or less; and
   (C) a total membrane area of the hollow fiber membranes is 70 m² or more.

<<Aspect 11>> The hollow fiber membrane module according to Aspect 10, wherein an effective length of the hollow fiber membranes is 1.6 m or more.

<<Aspect 12>> The hollow fiber membrane module according to Aspect 10 or 11, wherein the adhesive fixing portion of the hollow fiber membrane module does not have a restricting member for restricting an arrangement of the hollow fiber membranes.

<<Aspect 13>> The hollow fiber membrane module according to Aspect 12, wherein
hollow portions of the hollow fiber membranes are open in the first adhesive fixing layer, and
hollow portions of the hollow fiber membranes are sealed at the second adhesive fixing layer.

<<Aspect 14>> The hollow fiber membrane module according to any one of Aspects 10 to 13, wherein the second adhesive fixing layer has a hole penetrating the second adhesive fixing layer.

<<Aspect 15>> A filtration method, in which raw water is filtered using the hollow fiber membrane module according to any one of Aspects 10 to 14, wherein
the filtration method comprises
   a filtration step of filtering by external pressure filtration to cause raw water to pass through the hollow fiber membranes to obtain filtered water; and
   a cleaning step which is carried out after the filtration step, wherein
the cleaning step is the method for cleaning according to any one of Aspects 1 to 6.

<<Aspect 16>> A filtration method for filtering raw water using the hollow fiber membrane module according to any one of Aspects 10 to 14, wherein
the filtration method comprises
   a filtration step of filtering by external pressure filtration to cause raw water to pass through the hollow fiber membranes to obtain filtered water; and
   a cleaning step which is carried out after the filtration step,
the cleaning step comprises in the following order:
   a first cleaning step of carrying out reverse-flow cleaning or flushing and a second cleaning step, and
in the second cleaning step,
   reverse-flow cleaning, in which the filtered water from an interior side to an exterior side of the hollow fiber membranes, or flushing, in which raw water is introduced from the inlet and discharged from the cleaning outlet; and
   air scrubbing, in which raw water containing air bubbles is introduced from the inlet and discharged from the cleaning outlet and the hollow fiber membranes are shaken by the air bubbles, are carried out in combination, whereby reverse-flow cleaning-air scrubbing simultaneous cleaning or flushing-air scrubbing simultaneous cleaning is carried out to clean an exterior surface of the hollow fiber membranes.

<<Aspect 17>> The method for cleaning a hollow fiber membrane module according to Aspect 16, further comprising a third cleaning step after the first cleaning step and the second cleaning step, wherein
the third cleaning step is a step of carrying out at least one treatment of the following (C1) and (C2):
   (C1) a flushing treatment by passing water through a raw water side of the hollow fiber membranes; and
   (C2) a reverse-flow cleaning treatment by passing water from a filtered water side to a raw water side of the hollow fiber membranes.

<<Aspect 18>> The filtration method according to Aspect 16 or 17, comprising a discharging step of discharging cleaning waste liquid outside the hollow fiber membranes and in hollow portions thereof from the inlet or the cleaning outlet after the cleaning step.

<<Aspect 19>> The filtration method according to Aspect 18, wherein the discharging step is a step of introducing compressed air into the inlet or the cleaning outlet to forcibly discharge the cleaning waste liquid.

<<Aspect 20>> The filtration method according to any one of Aspects 16 to 19, wherein an average turbidity of the raw water is 10 degrees or more.

### Advantageous Effects of Invention

According to the present invention, a method for cleaning a hollow fiber membrane module in which the deterioration of filtration performance is remarkably suppressed when the hollow fiber membrane module is used for a long period of time is provided.

### BRIEF DESCRIPTION OF DRAWINGS

FIG. 1 is a schematic cross-sectional view showing an example of the structure of a hollow fiber membrane module to which the method for cleaning a hollow fiber membrane module of the present invention is applied.

FIG. 2 is a flow diagram of an example of a filtration system for carrying out the method for cleaning a hollow fiber membrane module of the present invention.

### DESCRIPTION OF EMBODIMENTS

The method for cleaning a hollow fiber membrane module of the present invention is
a method for cleaning a hollow fiber membrane which comprises a hollow fiber membrane for filtering raw water containing a suspended component, comprising in the following order:
a first cleaning step of removing the suspended component accumulated on the hollow fiber membrane; and
a second cleaning step of carrying out an air scrubbing treatment by passing a gas through at least a raw water side of the hollow fiber membrane, wherein
with respect to a capacity of the hollow fiber membrane, 50% by volume or greater of water present in the hollow fiber membrane module before cleaning is removed in the first cleaning step.

### <<Hollow Fiber Membrane Module>>

In raw water membrane filtration, a hollow fiber membrane module packed with a plurality of hollow fibers in a casing is preferably used because of a large membrane area per unit volume and high filtration efficiency thereof.

Known hollow fiber membrane modules include external pressure filtration hollow fiber membrane modules in which raw water is supplied to an exterior surface side and passed through an interior surface side of the hollow fiber membranes for filtration and internal pressure filtration hollow fiber membrane module in which raw water is supplied to an interior surface side and passed through an exterior surface side of the hollow fiber membranes for filtration. Of these, the external pressure filtration hollow fiber membrane modules have a larger effective membrane area per unit volume than the internal pressure filtration hollow fiber membrane modules and are thus used in fields where reduction of water production costs is required, such as the process of purified water production.

When the method for cleaning a hollow fiber membrane module of the present invention is applied to an external pressure filtration hollow fiber membrane module, the present invention is expected to exhibit the maximum advantageous effect.

The hollow fiber membrane module to which the cleaning method of the present invention is applied is preferably a hollow fiber membrane module comprising:
a hollow fiber membrane bundle composed of a plurality of hollow fiber membranes;
a housing in which the hollow fiber membrane bundle is housed;
an adhesive fixing portion by which both ends of the hollow fiber membrane bundle are adhesively fixed to the housing;
an inlet for communicating between an exterior portion of the hollow fiber membrane module and an exterior space of the hollow fiber membranes;
a filtered water port for communicating between an exterior portion of the hollow fiber membrane module and interior spaces of the hollow fiber membranes; and
a cleaning outlet for communicating between an exterior portion of the hollow fiber membrane module and an exterior space of the hollow fiber membranes.

The above adhesive fixing portion may comprise
a first adhesive fixing layer for adhesively fixing hollow fiber membranes to each other and the hollow fiber membrane bundle to an interior wall of the housing via a resin material at one end of the hollow fiber membranes; and
a second adhesive fixing layer for adhesively fixing the hollow fiber membranes to each other and the hollow fiber membrane bundle to an interior wall of the housing via a resin material at the other end of the hollow fiber membranes.

The hollow fiber membrane module to which the cleaning method of the present invention is applied is preferably a hollow fiber membrane module comprising:
a hollow fiber membrane bundle composed of a plurality of hollow fiber membranes;
a housing in which the hollow fiber membrane bundle is housed; and
an adhesive fixing portion by which both ends of the hollow fiber membrane bundle are adhesively fixed to the housing, wherein
the hollow fiber membranes are microfiltration (MF) membranes or ultrafiltration (UF) membranes,
the adhesive fixing portion comprises
   a first adhesive fixing layer for adhesively fixing hollow fiber membranes to each other and the hollow fiber membrane bundle to an interior wall of the housing via a resin material at one end of the hollow fiber membranes; and
   a second adhesive fixing layer for adhesively fixing the hollow fiber membranes to each other and the hollow fiber membrane bundle to an interior wall of the housing via a resin material at the other end of the hollow fiber membranes, and
the hollow fiber membrane module comprises
   an inlet for communicating between an exterior portion of the hollow fiber membrane module and a space outside the hollow fiber membranes;
   a filtered water port for communicating between an exterior portion of the hollow fiber membrane module and spaces inside the hollow fiber membranes; and
   a cleaning outlet for communicating between an exterior portion of the hollow fiber membrane module and a space outside the hollow fiber membranes.

It is particularly preferable that the hollow fiber membrane module to which the cleaning method of the present embodiment is applied satisfy all of the following conditions (A), (B), and (C):
(A) a packing rate of the hollow fiber membranes, which is expressed as a ratio of a total cross-sectional area of the hollow fiber membranes to an internal cross-sectional area of the housing, is 38% or less;
(B) an outer diameter of the hollow fiber membranes is 1.1 mm or less; and
(C) a total membrane area of the hollow fiber membranes is 70 m² or more. A hollow fiber membrane module which satisfies all of the conditions (A), (B), and (C) may not be subjected to the first cleaning step in the cleaning step, and a high cleaning effect can be obtained even without the first cleaning step.

### <Hollow Fiber Membrane Bundle>

The hollow fiber membrane bundle in the hollow fiber membrane module of the present embodiment is composed of a plurality of hollow fiber membranes and housed in a housing for use.

It is preferable that the number of hollow fiber membranes in the hollow fiber membrane bundle, when housed in a housing, be appropriately set so as to satisfy a predetermined packing rate. The number of hollow fiber membranes in the hollow fiber membrane bundle may be, for example, 1,000 or greater and 100,000 or less, 2,000 or greater and 50,000 or less, 3,000 or greater and 40,000 or less, or 5,000 or greater and 30,000 or less.

### (Hollow Fiber Membranes)

The hollow fiber membranes in the hollow fiber membrane bundle of the present embodiment are microfiltration (MF) membranes or ultrafiltration (UF) membranes.

Therefore, the average pore size of the hollow fiber membranes is 1 nm (0.001 μm) or more and 10 μm or less, preferably 10 nm (0.01 μm) or more and 700 nm (0.7 μm) or less, and more preferably 20 nm (0.02 μm) or more and 600 nm (0.6 μm) or less. When the average pore size is 30 nm (0.03 μm) or more and 400 nm (0.4 μm) or less, separation performance is sufficient while pore communication can be ensured.

The average pore size of the hollow fiber membranes can be measured according to the method (also known as half dry process) for measuring mean flow pore size specified in ASTM: F316-86.

The surface opening ratio of the hollow fiber membranes is preferably 25 to 60%, more preferably 25 to 50%, and even more preferably 25 to 45%. This surface opening ratio is the surface opening ratio of surfaces (preferably, exterior surfaces of the hollow fiber membranes) in contact with raw water among surfaces of the hollow fiber membranes. In the hollow fiber membranes, when the surface opening ratio of the surfaces in contact with raw water is 25% or greater, membrane clogging and deterioration of water permeability due to abrasion of membrane surfaces can be suppressed, and thus filtration stability can be increased. However, when the surface opening ratio is too high, the required separation performance may not be exhibited.

The surface opening ratio of the hollow fiber membranes can be determined from electron micrographs of exterior surfaces of the hollow fiber membranes.

Specifically, an electron micrograph of a hollow fiber membrane surface is subjected to black-and-white binarization of the pore portion open on the surface and the non-pore portion to obtain the area of each portion, and the surface opening ratio can be determined by substituting the obtained area of each portion into the following formula:

Opening ratio [%]=100×(pore portion area)/{(pore portion area)+(non-pore portion area)}

It is preferable that the magnification of the electron micrograph used to calculate the surface opening ratio be sufficiently large so that the shape of pores open on the exterior surfaces of the hollow fiber membranes can be clearly recognized. However, an excessively large magnification is inappropriate from the viewpoint of only sufficiently enlarging the viewing area to find the averaged surface opening ratio.

From these viewpoints, the magnification of electron micrographs can be set according to the cumulative median diameter (pore size corresponding to cumulative area value of 50%) of pores open on the exterior surfaces of the hollow fiber membranes, for example, as follows:
when cumulative median diameter is about 1 to 10 μm, magnification is 1,000 to 5,000×;
when cumulative median diameter is about 0.1 to 1 μm, magnification is 5,000 to 20,000×; and
when cumulative median diameter is about 0.03 to 0.1 μm, magnification is 10,000 to 50,000×.

Black-and-white binarization processing may be carried out by a commercial image analysis system using the electron micrographs or copies thereof.

The porosity of the hollow fiber membranes is preferably 50 to 80%, and more preferably 55 to 65%. By setting the porosity to 50% or greater, water permeability can be increased, and by setting the porosity to 80% or less, mechanical strength can be increased.

The inner diameter of the hollow fiber membranes is preferably 0.10 to 1.00 mm, and more preferably 0.30 to 0.80 mm.

The outer diameter of the hollow fiber membranes is 1.10 mm or less, preferably 0.3 to 1.05 mm, and more preferably 0.5 to 1.00 mm.

The thickness of the hollow fiber membranes is preferably 80 to 1,000 μm, and more preferably 100 to 300 μm. When the thickness is 80 μm or more, strength of the membrane can be ensured, and when the thickness is 1000 μm or less, pressure loss due to membrane resistance can be suppressed.

### (Raw Material (Material) of Hollow Fiber Membranes)

The hollow fiber membranes in the hollow fiber membrane module of the present embodiment are preferably composed of a synthetic resin porous membrane.

The resin constituting the hollow fiber membranes in the present embodiment is preferably a thermoplastic resin, and more preferably a polyolefin.

Examples of the polyolefin include polyethylene, polypropylene, polyvinyl alcohol, ethylene-vinyl alcohol copolymers, and fluororesins, and mixtures thereof. Examples of the above fluororesin include those selected from the group consisting of vinylidene fluoride resins (PVDF), chlorotrifluoroethylene resins, tetrafluoroethylene resins, ethylene-tetrafluoroethylene copolymers (ETFE), ethylene-monochlorotrifluoroethylene copolymers (ECTFE), ethylene-chlorotrifluoroethylene copolymers, polyvinylidene fluoride (which may comprise hexafluoropropylene domains), and hexafluoropropylene resins, and mixtures of these resins.

Of the polyolefins, fluororesins are particularly preferable as the resin constituting the hollow fiber membranes in the present embodiment.

These resins are excellent in handleability and toughness, and are thus excellent materials for hollow fiber membranes. Of these, a homopolymer selected from the group consisting of vinylidene fluoride, tetrafluoroethylene, hexafluoropropylene, ethylene, tetrafluoroethylene, and chlorotrifluoroethylene, or a copolymer of two or more selected from the above group, or a mixture of the homopolymer and the copolymer is excellent in mechanical strength and chemical strength (chemical resistance) and satisfactory in moldability, and is thus preferable. More specifically, fluororesins such as polyvinylidene fluoride, vinylidene fluoride-hexafluoropropylene copolymer, ethylene-tetrafluoroethylene copolymer, and ethylene-chlorotrifluoroethylene copolymer are preferable.

The thermoplastic resin constituting the hollow fiber membranes in the present embodiment preferably has a three-dimensional network structure instead of a spherulite structure. By constituting the hollow fiber member with a thermoplastic resin having a three-dimensional network structure, communication of pores from the interior surfaces to the exterior surfaces of the hollow fiber membranes can be improved.

### (Physical Properties of Hollow Fiber Membranes)

The initial value of tensile elongation at break for the hollow fiber membranes is preferably 60% or greater, more preferably 80% or greater, even more preferably 100% or greater, and particularly preferably at 120% or greater.

The compressive strength of the hollow fiber membranes is preferably 0.2 MPa or more, more preferably 0.3 to 1.0 MPa, and even more preferably 0.4 to 1.0 MPa.

### (Manufacturing Method of Hollow Fiber Membranes)

The hollow fiber membranes in the present embodiment can be manufactured by a known method or a method appropriately modified by a person skilled in the art based thereon.

The hollow fiber membranes in the present embodiment can be manufactured, for example, by extrusion molding of a melt-kneaded material comprising a thermoplastic resin as a raw material.

### <Housing>

The housing in the hollow fiber membrane module of the present embodiment houses the hollow fiber membrane bundle.

The housing and the hollow fiber membrane bundle are fixed together by an adhesive fixing portion described below to form a hollow fiber membrane module, and then, the interior of the module is divided into an exterior space of the hollow fiber membranes and interior spaces of the hollow fiber membranes, and has a structure of these spaces in contact via the hollow fiber membranes.

The housing in the present embodiment is provided with an inlet, a filtered water port, and a cleaning outlet. After the housing and the hollow fiber membrane bundle are fixed by an adhesive fixing portion described below, the inlet, the filtered water port, and the cleaning outlet have the following functions as the inlet, filtered water port, and cleaning outlet of the hollow fiber membrane module.
Inlet: a function of communicating between the exterior portion of the module and the exterior space of the hollow fiber membranes
Filtered water port: a function of communicating between the exterior portion of the module and the interior spaces of the hollow fiber membranes
Cleaning outlet: a function of communicating between the exterior portion of the module and the exterior space of the hollow fiber membranes

The housing may include a first tubular member for housing the hollow fiber membrane bundle and a second tubular member for arranging the adhesive fixing portion. The second tubular member is preferably arranged at both ends of the first tubular member.

The second tubular member may have the above inlet, the filtered water port, and the cleaning outlet.

Preferably, the second tubular member may be composed of a second tubular member A arranged on the side of the hollow fiber membrane module from which the filtrate is drained and having a filtered water port and a cleaning outlet; and a second tubular member B arranged on the side of the hollow fiber membrane module from which raw water is introduced and having an inlet.

The inner diameter of the first tubular member of the housing is preferably 170 mm or more and more preferably 190 mm or more, and preferably 250 mm or less and more preferably 230 mm or less. The outer diameter of the first tubular member may be, for example, 170 mm or more and 300 mm or less. The length of the first tubular member may be appropriately set according to the desired effective length of the hollow fiber membranes, for example, may be 1.0 m or more and 3.0 m or less, and is preferably 1.5 m or more and 2.0 m or less.

The inner diameter of the second tubular member of the housing may be larger than the inner diameter of the first tubular member, and is preferably 180 mm or more and more preferably 200 mm or more, and is preferably 280 mm or less and more preferably 250 mm or less. The outer diameter of the second tubular member may be, for example, 180 mm or more and 330 mm or less. The length of the second tubular member may be appropriately set, and may be, for example, 0.2 m or more and 1.0 m or less.

The material of the housing may be appropriately set from the viewpoint of moldability, cost, mechanical durability, and chemical durability. The housing is preferably composed of a material selected from, for example, stainless steel, ABS, PVC, nylon, PSF, PE, PP, and PPE.

### <Fixation of Hollow Fiber Membrane Bundle to Housing>

In the hollow fiber membrane module of the present embodiment, the hollow fiber membrane bundle and the housing are fixed together by an adhesive fixing portion.

### <Adhesive Fixing Portion>

The adhesive fixing portion in the hollow fiber membrane module of the present embodiment has a function of adhesively fixing the hollow fiber membrane bundle and the housing together.

The adhesive fixing portion comprises
a first adhesive fixing layer for adhesively fixing hollow fiber membranes to each other and the hollow fiber membrane bundle to an interior wall of the housing via a resin material at one end of the hollow fiber membranes; and
a second adhesive fixing layer for adhesively fixing the hollow fiber membranes to each other and the hollow fiber membrane bundle to an interior wall of the housing via a resin material at the other end of the hollow fiber membranes.

The material constituting the first adhesive fixing layer and the second adhesive fixing layer of the adhesive fixing portion is a resin material. Examples of the resin material can include urethane resins, epoxy resins, acrylic resins, and silicone resins.

A restricting member for restricting the arrangement of the hollow fiber membranes may be set within the adhesive fixing portion of the hollow fiber membrane module. However, it is preferable that there be no restricting member within the adhesive fixing portion because the existing material density of the hollow fiber membranes is decreased and a suspended component in raw water is easily discharged.

### (First Adhesive Fixing Layer)

The first adhesive fixing layer has the function of adhesively fixing the hollow fiber membranes to each other and the hollow fiber membrane bundle to an interior wall of the housing at one end of the hollow fiber membranes.

The first adhesive fixing layer may be arranged at an interior portion of the second tubular member A. Preferably, the first adhesive fixing layer is arranged at an interior portion of the second tubular member A so that the filtered water port and the cleaning outlet are blocked, and divides the interior portion of the second tubular member A into the space on the filtered water side and the space of the cleaning outlet.

It is preferable that the hollow portions of the hollow fiber membranes be open in the first adhesive fixing layer.

According to the above,
the interior spaces of the hollow fiber membranes communicate with an exterior portion of the hollow fiber membrane module via a space on the filtered water side of the interior portion of the second tubular member A, and
the exterior space of the hollow fiber membranes communicates with an exterior portion of the hollow fiber membrane module via a space on the cleaning outlet side of the interior portion of the second tubular member A. Thus, it is possible that a cleaning waste liquid within the exterior space of the hollow fiber membranes and filtered water within the interior spaces of the hollow fiber membranes are drained separately into the exterior portion of the hollow fiber membrane module.

### (Second Adhesive Fixing Layer)

The second adhesive fixing layer has the function of adhesively fixing the hollow fiber membranes to each other and the hollow fiber membrane bundle to an interior wall of the housing at the other end (the end on the side opposing the first adhesive fixing layer) of the hollow fiber membranes.

The second adhesive fixing layer may be arranged at an interior portion of the second tubular member B.

The second adhesive fixing layer preferably has a hole penetrating the second adhesive fixing layer.

It is preferable that the hollow portions of the hollow fiber second adhesive fixing layer be sealed at the second adhesive fixing layer.

According to the above, the exterior space of the hollow fiber membranes communicates with an exterior portion of the hollow fiber membrane module via the space of the interior portion of the second tubular member B and the hole penetrating the second adhesive fixing layer. Thus, raw water can be introduced from an exterior portion of the hollow fiber membrane module to the exterior of the hollow fiber membranes.

The diameter of the hole present in the second adhesive fixing layer is preferably 5 mm or more and 30 mm or less. The number of holes is preferably 5 or greater and 100 or less. The shape of the hole can be selected from, for example, a circle, an ellipse, a rectangle, a polygon, and a combination thereof, or may be an irregular shape.

### (Shape of Hollow Fiber Membrane Module)

The hollow fiber membrane module of the present embodiment preferably satisfies all of the following conditions (A), (B), and (C):
(A) a packing rate of the hollow fiber membranes, which is expressed as a ratio of a total cross-sectional area of the hollow fiber membranes to an internal cross-sectional area of the housing, is 38% or less;
(B) an outer diameter of each of the hollow fiber membranes is 1.1 mm or less; and
(C) a membrane area of the hollow fiber membrane module is 70 m² or more.

As described above, the “packing rate of the hollow fiber membranes” is a ratio of the hollow fiber membrane cross-sectional area calculated according to “total hollow fiber cross-sectional area/housing internal cross-sectional area”, and the hollow fiber membrane cross-sectional area herein refers to a sum of the cross-sectional areas including the hollow portions of the membranes. In addition, when the housing is composed of the first tubular member and the second tubular member, the “housing internal cross-sectional area” refers to a cross-sectional area of the interior side of the first tubular member housing the hollow fiber membrane bundle.

It is preferable that comparatively thin hollow fiber membranes having an exterior diameter of 1.1 mm or less be used in the hollow fiber membrane module of the present embodiment, whereby the total membrane area of the hollow fiber membrane bundle can be increased even when the packing rate of the hollow fiber membranes is reduced to 38%. Further, reducing the packing rate of the hollow fiber membranes to 38% or less is advantageous in that the dischargeability of a suspended component is improved and a large membrane area can be ensured.

The packing rate of the hollow fiber membranes is preferably 38% or less, and more preferably 37% or less, from the viewpoint of suspended component dischargeability. The packing rate of the hollow fiber membranes is preferably 30% or greater, and more preferably 35% or greater.

The effective length of the hollow fiber membranes is preferably 1.5 m or more, more preferably 1.6 m or more, even more preferably 1.7 m or more, and particularly preferably 1.8 m or more, from the viewpoint of filtration efficiency. The effective length of the hollow fiber membranes refers to a hollow fiber membrane length that contributes to filtration, and means an average value of the lengths of the hollow fiber membranes which are exposed between the first adhesive fixing layer and the second adhesive fixing layer.

The total membrane area of the hollow fiber membranes is preferably 70 m² or more, more preferably 80 m² or more, and even more preferably 90 m² or more. Because the total membrane area of the hollow fiber membranes is large, the hollow fiber membrane module of the present embodiment has an advantage of high filtration efficiency. The total membrane area of the hollow fiber membranes refers to a total hollow fiber membrane area that contributes to filtration (effective membrane area), and is a total exterior area of the hollow fiber membrane portions which are exposed between the first adhesive fixing layer and the second adhesive fixing layer.

The hollow fiber membrane module of the present application has a large footprint.

The “footprint” herein is defined as a value obtained by dividing the total membrane area of the hollow fiber membranes by the cross-sectional area of the first tubular member of the module.

A hollow fiber membrane module having a large footprint is preferable because a large volume of water can be treated with a small installation area.

The footprint of the hollow fiber membrane module of the present embodiment is preferably 2,500 m²/m² or more, more preferably 2,600 m²/m² or more, and even more preferably 2,700 m²/m² or more. Particularly, the footprint may be 2,800 m²/m² or more, 2,900 m²/m² or more, or 3,000 m²/m² or more.

However, to satisfy the requirement that the hollow fiber membrane packing rate should fall within a predetermined range, the footprint is preferably 5,000 m²/m² or less, more preferably 4,500 m²/m² or less, and even more preferably 4,000 m²/m² or less. Particularly, the footprint may be 3,500 m²/m² or less.

### <Manufacturing Method of Hollow Fiber Membrane Module>

The hollow fiber membrane module of the present embodiment can be manufactured, for example, by the following method.

First, a predetermined number of hollow fiber membranes are prepared as a bundle to produce a hollow fiber membrane bundle. Subsequently, the hollow fiber membrane bundle is hung vertically, and the lower end portion is trimmed. The periphery of the hollow fiber membrane bundle is then secured with tape to define the circumference, followed by impregnating the lower end face of the hollow fiber membranes with an adhesive such as a urethane resin and curing to fix the hollow fiber membrane bundle at a predetermined diameter and seal the hollow portions of the lower end face.

Next, by joining a second tubular member A and a second tubular member B to both ends of a first tubular member into which the hollow fiber membrane bundle is inserted, a housing is formed and at the interior portion thereof the hollow fiber membrane bundle is housed. At this time, the hollow fiber membrane bundle is inserted so that the side where the hollow portions are sealed is positioned on the second tubular member A side.

When the second tubular member A is joined to the first tubular member, a rectifying tube may be installed at the interior portion of the second tubular member A.

Columnar members for forming holes penetrating a second adhesive fixing layer are inserted at positions where the second adhesive fixing layer is formed at an end portion of the hollow fiber membrane bundle. The diameter and number of the columnar members are set according to the desired diameter and number of holes.

Next, a potting material (for example, urethane resin) is injected into both ends of the housing. The housing having the potting material injected thereinto is then rotated horizontally to carry out centrifugal bonding, thereby forming an adhesive portion (the first adhesive fixing layer and the second adhesive fixing layer).

After the adhesive fixing portion is formed, the columnar members for forming holes are removed and through-holes are formed.

The end portion of the first adhesive fixing layer is then cut off to open the end portion on the filtered water side of the hollow fiber membrane bundle, whereby the hollow fiber membrane module of the present embodiment can be obtained.

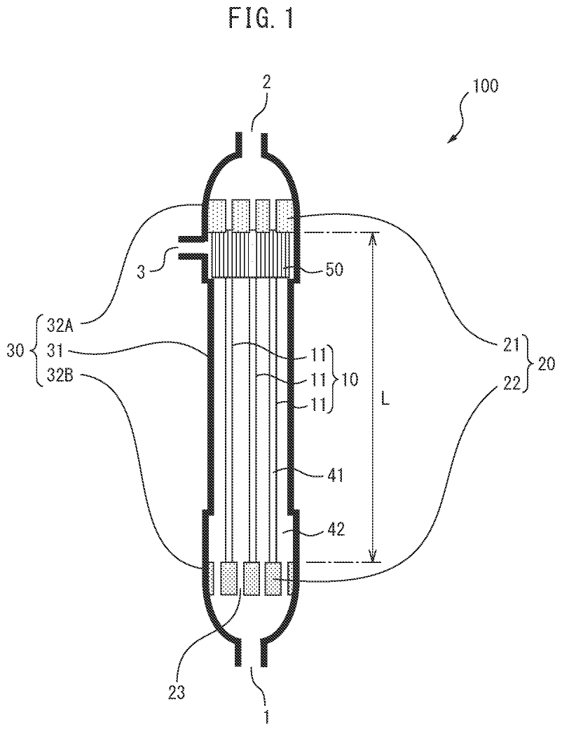

FIG. 1 shows an example of the structure of a hollow fiber membrane module to which the method for cleaning a hollow fiber membrane module of the present invention is applied, as a schematic cross-sectional view.

The hollow fiber membrane module (100) in FIG. 1 comprises
a hollow fiber membrane bundle (10) composed of a plurality of hollow fiber membranes (11);
a housing (30) in which the hollow fiber membrane bundle (10) is housed;
an adhesive fixing portion (20) for adhesively fixing both end portions of the hollow fiber membrane bundle (10) to the housing (30);
an inlet (1) for communicating between an exterior portion of the hollow fiber membrane module (100) and an exterior space (42) of the hollow fiber membranes (11);
a filtered water port (2) for communicating between an exterior portion of the hollow fiber membrane module (100) and interior spaces (41) of the hollow fiber membranes (11); and
a cleaning outlet (3) for communicating between an exterior portion of the hollow fiber membrane module (100) and an exterior space (42) of the hollow fiber membranes (11).

The housing (30) includes a first tubular member (31) for housing the hollow fiber membrane module (10) and two second tubular members (32A, 32B) for arranging the adhesive fixing portion (20), wherein the two second tubular members are arranged on the ends of the first tubular member (31).

The second tubular members are composed of
a second tubular member A (32A) arranged on the side where filtered water in the hollow fiber membrane module (100) is drained and having the filtered water port (2) and the cleaning outlet (3); and
a second tubular member B (32B) arranged on the side where raw water in the hollow fiber membrane module (100) is introduced and having an inlet (1). However, the arrangement positions of the inlet (1), the filtered water port (2), and the cleaning outlet (3) are not limited to this embodiment.

The adhesive fixing portion (20) comprises
a first adhesive fixing layer (21) for adhesively fixing the hollow fiber membranes (11) to each other and the hollow fiber membrane bundle (10) to an interior wall of the second tubular member A (32A) in the housing (30) via a resin material at one end of the hollow fiber membranes (11), and
a second adhesive fixing layer (22) for adhesively fixing the hollow fiber membranes (11) to each other and the hollow fiber membrane bundle (10) to an interior wall of the second tubular member B (32B) in the housing (30) via a resin material at the other end of the hollow fiber membranes (11).

The first adhesive fixing layer (21) is arranged at an interior portion of the second tubular member A (32A) so that the filtered water port (2) and the cleaning outlet (3) are blocked, and divides the interior portion of the second tubular member A (32A) into a space on the filtered water port (2) side and a space on the cleaning outlet (3) side.

The hollow portions of the hollow fiber membranes (11) are open in the first adhesive fixing layer (21).

According to the above,
the interior spaces of the hollow fiber membranes (11) communicate with the exterior portion of the hollow fiber membrane module (100) via a space on the filtered water port (2) side of the second tubular member A (32A) interior portion, and
the exterior space of the hollow fiber membranes (11) communicates with the exterior portion of the hollow fiber membrane module (100) via a space on the cleaning outlet (3) side of the second tubular member A (32A) interior portion. Thus, it is possible that a cleaning waste liquid within the exterior space of the hollow fiber membranes (11) and filtered water within the interior spaces of the hollow fiber membranes (11) are drained separately into the exterior portion of the hollow fiber membrane module (100).

The second adhesive fixing layer (22) is arranged at an interior portion of the second tubular member B (32B).

The second adhesive fixing layer (22) has holes penetrating the second adhesive fixing layer (22).

The hollow portions of the hollow fiber membranes (11) are sealed at the second adhesive fixing layer (22).

According to the above, the exterior space of the hollow fiber membranes (11) communicates with the exterior portion of the hollow fiber membrane module (100) via the space at the interior portion of the second tubular member B (32B) and the holes penetrating the second adhesive fixing layer (22). Thus, raw water can be introduced from the exterior portion of the hollow fiber membrane module (100) to the exterior of the hollow fiber membranes (11).

The hollow fiber membrane module (100) in FIG. 1 further comprises a rectifying tube (50), which is an optional member, at the interior portion of the second tubular member A in the housing (30).

Note that, the distance between the first adhesive fixing layer (21) and the second adhesive fixing layer (22), which defines the effective length of the hollow fiber membranes (11), is indicated by a symbol “L” in FIG. 1.

### <<Method for Cleaning Hollow Fiber Membrane Module>>

The method for cleaning a hollow fiber membrane module of the present invention is
a method for cleaning a hollow fiber membrane module which comprises hollow fiber membranes for filtering raw water containing a suspended component, comprising in the following order:
a first cleaning step of removing the suspended component accumulated on the hollow fiber membranes; and
a second cleaning step of carrying out an air scrubbing treatment by passing a gas through at least a raw water side of the hollow fiber membranes.

The first cleaning step is preferably a step of carrying out at least one treatment of the following (A1) to (A3):
(A1) a reverse-flow cleaning (backwashing) treatment by passing water from a filtered water side to a raw water side of the hollow fiber membranes;
(A2) a flushing treatment by passing water through a raw water side of the hollow fiber membranes; and
(A3) a draining treatment by discharging a liquid within the hollow fiber membrane module.

The second cleaning step is a step of removal, preferably to the exterior of the module, with the aim to complete the removal of the suspended component from the hollow fiber membranes in the first cleaning step.

At least an air scrubbing treatment is carried out in the second cleaning step.

The second cleaning step is preferably a step of carrying out any of the following (B1) to (B3):
(B1) a step of carrying out only the air scrubbing treatment;
(B2) a step of simultaneously carrying out the air scrubbing treatment and a reverse-flow cleaning (backwashing) treatment; and
(B3) a step of simultaneously carrying out the air scrubbing treatment and a flushing treatment.

The first cleaning step and the second cleaning step may be followed by a third cleaning step of discharging the suspended component removed in the first cleaning step and the second cleaning step to the exterior of the hollow fiber membrane module.

The method for cleaning a hollow fiber membrane module of the present invention is intended to be carried out following a filtration step of filtering raw water by the hollow fiber membrane module. Preferably, it is planned that the filtration step and the cleaning steps of the method for cleaning a hollow fiber membrane module of the present invention are repeated and the hollow fiber membrane module can be thereby continuously operated for a long period of time.

The timing of stopping the filtration step and starting the cleaning steps may be set appropriately. For example, after starting or restarting the filtration step, when a predetermined time has elapsed, the filtration step may be stopped and the cleaning steps may be started. Alternatively, when water permeability of the filtration step reaches a preset and predetermined value, the filtration step may be stopped and the cleaning steps may be started.

Hereinafter, each of the filtration step and the reverse-flow cleaning (backwashing treatment), flushing treatment, and air scrubbing treatment that are carried out in the first to third cleaning steps in the method for cleaning a hollow fiber membrane module of the present invention will first be described. The first to third cleaning steps in the method for cleaning a hollow fiber membrane module of the present invention will then be described.

Note that, backwashing will be referred to herein as “BW”, flushing as “FL”, draining as “DL”, air scrubbing as “AS”, simultaneous execution of backwashing and air scrubbing (backwashing-air scrubbing simultaneous cleaning) as “ASBW”, and simultaneous execution of flushing and air scrubbing (flushing-air scrubbing simultaneous cleaning) as “ASFL”.

### <Filtration Step>

The filtration step is a step of obtaining filtered water by supplying raw water to a raw water side of hollow fiber membranes, capturing an insoluble component in the raw water with the hollow fiber membranes, and allowing the filtered water to percolate to a filtered water side of the hollow fiber membranes. If the hollow fiber membrane module is an external pressure filtration hollow fiber membrane module, filtered water is obtained by supplying raw water from an exterior side of the hollow fiber membranes and passing the raw water through the hollow fiber membranes by external pressure filtration. In the hollow fiber membrane module of the present embodiment, employing a system in which raw water is introduced from a lower side of a module and then subjected to external pressure filtration is preferable because the suspended component is easily discharged.

The raw water in the filtration step is not particularly limited, but is typically water containing a suspended substance that can be removed by a filtration step. Examples thereof include natural water, wastewater, process liquids, and treated water thereof.

Examples of natural water include river water, lake water, groundwater, and seawater. Wastewater includes sewage and industrial wastewater. Process liquid refers to a mixed liquid before separation into valuables and non-valuables in the fields of foods, pharmaceuticals, and semiconductor manufacturing. These raw waters may contain fine organic and inorganic matter in the order of μm or less, a suspended component composed of one or more organic-inorganic mixtures (humus colloid, organic collide, clay, and bacteria), or macromolecular substances derived from bacteria and algae.

The raw water quality can be defined by turbidity and/or organic concentration. Both turbidity and organic concentration are evaluated as average values, not instantaneous values.

Based on turbidity, raw water is classified into low turbidity water having a turbidity of less than 1, medium turbidity water having a turbidity of 1 or greater and less than 10, high turbidity water having a turbidity of 10 or greater and less than 50, and ultra-high turbidity water with a turbidity of 50 or greater.

Based on organic concentration (total organic carbon concentration (TOC): mg/L), raw water is classified into low TOC water of less than 1, medium TOC water of 1 or greater and less than 4, high TOC water of 4 or greater and less than 8, and ultra-high TOC water of 8 or greater.

Generally, the higher turbidity/TOC the water has, the more easily clogging of a porous filtration membrane occurs. Thus, the average turbidity of raw water supplied to the filtration step in the present embodiment is preferably 10 degrees or more, whereby the performance of the hollow fiber membrane module of the present embodiment can be suitably demonstrated.

When the hollow fiber membrane module is an external pressure filtration hollow fiber membrane module, the filtration step of the present embodiment is preferably carried out, for example, by introducing raw water from the inlet of the hollow fiber membrane module to the exterior space of the hollow fiber membranes; exuding the raw water as a filtrate which has passed through the thick portions of the hollow fiber membranes from the interior side surfaces of the hollow fiber membranes, and draining the filtrate in the interior spaces of the hollow fiber membranes from the outlet of the hollow fiber membrane module.

The flow rate of the filtrate per m² of membrane area, as permeable water flow rate represented by flow rate (L) per hour (LMH or L/[m²·h]), is preferably 10 to 500 LMH; more preferably 20 LMH or more, 40 LMH or more, or 50 LMH or more and 200 LMH or less; and even more preferably 40 LMH or more, 50 LMH or more, or 75 LMH or more and 150 LMH or less.

### <Reverse-Flow Cleaning Treatment: BW>

The reverse-flow cleaning (backwashing) treatment is a cleaning in which water is passed from the filtered water side to the raw water side of the hollow fiber membranes. If the hollow fiber membrane module is an external pressure filtration hollow fiber membrane module, water is passed from the interior side to the exterior side of the hollow fiber membranes.

Through the backwashing treatment, a suspended component accumulated within fine pores of thick portions of the hollow fiber membranes can be pushed out on the raw water side of the hollow fiber membranes.

The water passing from the filtered water side to the raw water side of the hollow fiber membranes may be, for example, filtered water.

The flow rate of water (preferably filtered water) during the backwashing treatment, as the permeable water flow rate, is preferably 0.1 to 3 times the permeable water flow rate of the filtration step, more preferably 0.3 to 3 times, even more preferably 0.5 to 3 times, and particularly preferably 0.7 to 3 times.

### <Flashing Treatment: FL>

The flushing treatment is a cleaning method in which water is passed through the raw water side of the hollow fiber membranes. If the hollow fiber membrane module is an external pressure filtration hollow fiber membrane module, water is passed through the exterior surfaces of the hollow fiber membranes.

Through the flushing treatment, a suspended component attached to the raw water side surface of the hollow fiber membranes can be cleaned away.

The amount of water passing through the raw water side of the hollow fiber membranes in the flushing treatment is set preferably to an amount of 0.3 to 3 times relative to the amount of water entering into the hollow fiber membrane module, and more preferably to an amount of 0.5 to 2 times.

### <Draining Treatment: DL>

The draining treatment is a step of discharging a cleaning waste liquid remaining at the interior portion of the hollow fiber membrane module.

By carrying out the draining treatment, a suspended component within the hollow fiber membrane module can be removed effectively.

The draining treatment can be carried out, for example, by introducing compressed air from the cleaning outlet of the hollow fiber membrane module, whereby the cleaning waste liquid remaining at the hollow fiber membrane module interior portion can be forcibly discharged from a lower portion of the module.

The amount of water remaining within the hollow fiber membrane module after the draining treatment is set preferably to an amount of 0.7 times or less relative to the amount of water entering into the hollow fiber membrane module, more preferably to an amount of 0.5 times or less, and even more preferably to an amount of 0.3 times or less.

### <Air Scrubbing Treatment: AS>

The air scrubbing treatment is a cleaning method in which compressed air is introduced from the inlet of the hollow fiber membrane module and discharged from the cleaning outlet to shake the hollow fiber membranes by air (air bubbles).

In the case of the air scrubbing treatment, the amount of compressed air introduced into the hollow fiber membrane module per m² of cross-sectional area of the housing of the hollow fiber membrane module is preferably 0.001 to 0.1015 to 1000 Nm³/h, more preferably 75 to 500 Nm³/h, even more preferably 150 to 400 Nm³/h, and particularly preferably 170 to 400 Nm³/h, and may further be 200 to 350 Nm³/h or 200 to 300 Nm³/h.

### <First Cleaning Step>

In the first cleaning step, a suspended component accumulated on the hollow fiber membranes is removed.

In the first cleaning step, as described above, it is preferable that at least one of (A1) a backwashing treatment, (A2) a flushing treatment, and (A3) a draining treatment be carried out.

When the first cleaning step is carried out by (A1) a backwashing treatment, the execution time is, for example, 10 to 120 s, preferably 15 to 60 s.

When the first cleaning step is carried out by (A2) a flushing treatment, the execution time is, for example, 10 to 120 s, preferably 15 to 60 s.

When the first cleaning step is carried out by (A3) a draining treatment, it is preferable that the (A3) draining treatment be carried out until the amount of water within the hollow fiber membrane module is decreased to the amount described above.

In the first cleaning step, the removal rate of suspended solids (S S) accumulated on the hollow fiber membranes is preferably 7% by mass or greater, more preferably 8% by mass or greater, even more preferably 10% by mass or greater, and may be 12% by mass or greater, 15% by mass or greater, 18% by mass or greater, or 20% by mass or greater.

The removal rate of suspended solids (SS) is represented as a ratio (percentage) of the amount of SS removed by the first cleaning step relative to the amount of suspended component introduced into the hollow fiber membrane module (introduced SS amount) in the filtration step. The introduced SS amount can be calculated from the difference between the suspended component amount contained in raw water and the suspended component amount contained in filtered water and the execution time of the filtration step.

### <Second Cleaning Step>

The second cleaning step is a step of removal, preferably to the exterior of the module, with the aim to complete the removal of the suspended component from the hollow fiber membranes in the first cleaning step.

At least an air scrubbing treatment is carried out in the second cleaning step.

The second cleaning step is preferably a step of carrying out any of the following (B1) to (B3):
(B1) a step of carrying out only the air scrubbing treatment (AS);
(B2) a step of simultaneously carrying out the air scrubbing treatment and a reverse-flow cleaning (backwashing) treatment (ASBW); and
(B3) a step of simultaneously carrying out air scrubbing treatment and a flushing treatment (ASFL).

When the second cleaning step is (B1) a step of carrying out only the air scrubbing treatment (AS), the execution time is, for example, 10 to 120 s, preferably 15 to 60 s.

When the second cleaning step is (B2) a step of simultaneously carrying out the air scrubbing treatment and the backwashing treatment (ASBW), the execution time is, for example, 10 to 120 s, preferably 15 to 60 s.

When the second cleaning step is (B3) a step of simultaneously carrying out the air scrubbing treatment and the flushing treatment (ASFL), the execution time is, for example, 10 to 120 s, preferably 15 to 60 s.

### <Third Cleaning Step>

The third cleaning step is a step optionally carried out after the first cleaning step and the second cleaning step.

The third cleaning step is a step of discharging the suspended component removed in the first cleaning step and the second cleaning step to the exterior portion of the hollow fiber membrane module.

In the third cleaning step, at least one treatment of the following (C1) and (C2) is carried out:
(C1) a flushing treatment by passing water through a raw water side of the hollow fiber membranes; and
(C2) a backwashing treatment by passing water from a filtered water side to a raw water side of the hollow fiber membranes.

In the third cleaning step, when the (C1) flushing treatment is carried out, the amount of water passed through the raw water side of the hollow fiber membranes is set preferably to an amount of 0.3 to 3 times the amount of water entering into the hollow fiber membrane module, and more preferably to an amount of 0.5 to 2 times.

In the third cleaning step, the amount of water when carrying out the (C2) backwashing treatment, as a permeable water flow rate, is preferably 0.1 to 3 times the permeable water flow rate of the filtration step, and more preferably 0.3 to 3 times.

When the third cleaning step is carried out, the execution time is preferably 10 to 120 s, more preferably 15 to 60 s.

### (Discharging Step)

In the filtration method of the present embodiment, a discharging step of discharging a cleaning waste liquid remaining at the interior portion of the hollow fiber membrane module after the cleaning step may be and is preferably carried out.

By carrying out the discharging step after the cleaning step, a suspended substance within the hollow fiber membrane module can be discharged more effectively.

The discharging step can be carried out, for example, by introducing compressed air from the cleaning outlet of the hollow fiber membrane module, whereby the cleaning waste liquid remaining at the hollow fiber membrane module interior portion can be forcibly discharged from a lower portion of the module.

The weight of the hollow fiber membrane module after the discharging step is preferably 1.70 times or less of the initial dry weight of the hollow fiber membrane module, more preferably 1.60 time or less, and even more preferably 1.55 times or less.

### Advantageous Effect

In the filtration method of the present embodiment, the number of broken hollow fiber membranes after repeating a predetermined cycle comprising a filtration step, a cleaning step, and preferably a discharging step for 20,000 times can be kept at 0.5% or less of the total number of hollow fiber membranes at the hollow fiber membrane module interior portion. In a preferable aspect of the present embodiment, the number of broken hollow fiber membranes after repeating the above cycle for 100,000 times or 200,000 times can be kept at 0.5% or less of the total number of hollow fiber membranes.

### (Maintainability of Water Permeability)

In the hollow fiber membrane module of the present embodiment, a predetermined cycle comprising a filtration step, a cleaning step, and preferably a discharging step is repeated for n−1 times. It is preferable that the water permeability Ln of the hollow fiber membrane module after carrying out the filtration step for the n^{th} time and the water permeability Ln+1 of the hollow fiber membrane module carrying out the n^{th} cleaning step and then the filtration step for the n+1^{th} time immediately after the filtration step satisfy the relation in the following formula:

105%≥(Ln+1/Ln)×100≥80%

As described herein, water permeability is a value [LMH/kPa] obtained by dividing the filtration flux [LHM] by the pressure at that time [kPa].

### <<Embodiment of Method for Cleaning Hollow Fiber Membrane Module>>

The method for cleaning a hollow fiber membrane module of the present invention can be carried out preferably following the filtration step in the above hollow fiber membrane module incorporated into a suitable filtration system.

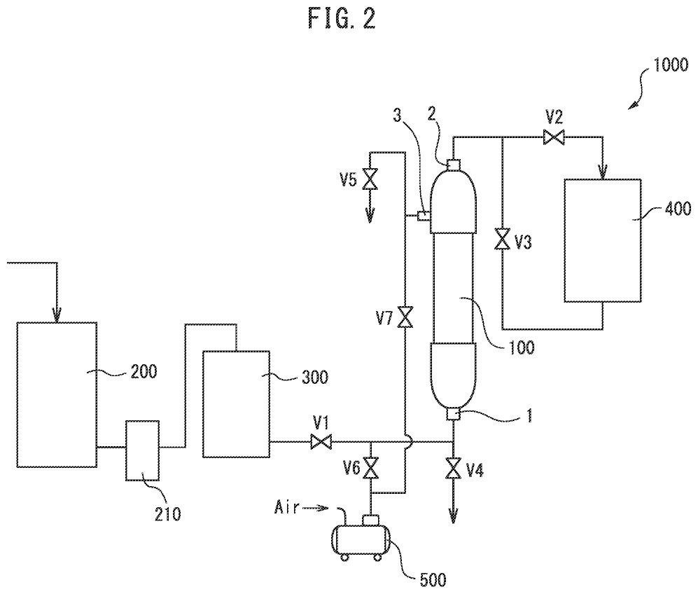

FIG. 2 shows a flow diagram of an example of a filtration system for carrying out the method for cleaning a hollow fiber membrane module of the present invention.

The filtration system (1000) in FIG. 2 has a configuration in which the hollow fiber membrane module (100) of the present embodiment, a raw water tank (200), a strainer (210), a raw water tank (300), a filtered water tank (400), and a compressor (500) are connected by pipes appropriately arranged with valves. Pumps for feeding liquid, drain pipes normally installed in each tank, chemical tanks for chemical cleaning and accompanying pipes, and sensors for checking operating conditions are omitted in FIG. 2.

Using the filtration system (1000) in FIG. 2, the filtration method of the present embodiment, comprising the predetermined filtration and cleaning steps, can be carried out, for example, as follows.

### <<Filtration Step (F)>>

In the filtration step, raw water is passed through the hollow fiber membranes in the hollow fiber membrane module and filtered to obtain filtered water.

In the filtration system (1000) in FIG. 2, a raw liquid such as an aqueous suspension or a process liquid is temporarily stored in the raw liquid tank (200), and then coarsely filtered by the strainer (210). The resulting coarsely filtered water is used as raw water in the filtration method of the present embodiment. The raw water is stored in the raw water tank (300). The raw water in the raw water tank (300) is introduced into the hollow fiber membrane module (100) from an inlet (1) via a raw water feed (V1), passed for filtration through thick portions of the hollow fiber membranes from the exterior side of the hollow fiber membranes, and percolates into the interior spaces of the hollow fiber membrane as filtered water. The filtered water which percolates into the interior spaces of the hollow fiber membranes is stored in the filtered water tank (400) via the filtered water port (2) and a filtered water supply valve (V2).

### <<Cleaning Step>>

In the cleaning step, a first cleaning step and a second cleaning step are carried out in this order, and an optional third cleaning step may be further carried out.

In the first cleaning step, at least one of (A1) a backwashing treatment (BW), (A2) a flushing treatment (FL), and (A3) a draining treatment (DL) is carried out.

In the second cleaning step, (B1) an air scrubbing treatment (AS), (B2) a backwashing-air scrubbing simultaneous cleaning (ASBW), or (B3) a flushing-air scrubbing simultaneous cleaning (ASFL) is carried out.

In the optional third cleaning step, at least one of (C1) a flushing treatment (FL) and (C2) a backwashing treatment (BW) is carried out.

Hereinafter, the method of carrying out the backwashing (BW), flushing treatment (FL), draining treatment (DL), air scrubbing treatment (AS), backwashing-air scrubbing simultaneous cleaning (ASBW), and flushing-air scrubbing simultaneous cleaning (ASFL) will be described using the filtration system (1000) in FIG. 2.

### <Backwashing (BW)>

In BW, filtered water is passed from the interior side to the exterior side of the hollow fiber membranes in the hollow fiber membrane module.

In this case, filtered water within the filtered water tank (400) is introduced into the hollow fiber membrane module (100) from the filtered water port (2) via a backwashing valve (V3), passed through thick portions of the hollow fiber membranes from the interior side of the hollow fiber membranes, and percolated to the exterior space of the hollow fiber membranes. In this step, suspended substance accumulated within the pores of the thick portions of hollow fiber membranes is pushed out to the exterior side of the hollow fiber membranes, thereby cleaning the hollow fiber membranes.

The filtered water which percolates to the exterior space of the hollow fiber membranes can be discharged by one of the following methods:
a method of discharging out of the system via the cleaning outlet (3) and a cleaning discharge valve (V5);
a method of discharging out of the system via the inlet (1) and a cleaning waste liquid drain valve (V4); and
a method of discharging out of the system via the cleaning outlet (3) and the cleaning discharge valve (V5) and via the inlet (1) and the cleaning waste liquid drain valve (V4).

### <Flashing Treatment (FL)>

In FL, raw water is passed through the exterior side of the hollow fiber membranes to clean away suspended material adhering to the exterior surfaces of the hollow fiber membranes by washing.

In the FL, raw water in the raw water tank (300) is introduced into the hollow fiber membrane module (100) from the inlet (1) via the raw water feed valve (V1), then passed through the exterior space of the hollow fiber membranes, and discharged out of the system via the cleaning outlet (3) and the cleaning waste liquid discharge valve (V5).

### <Draining Treatment (DL)>

In DL, the cleaning waste liquid remaining at the interior portion of the hollow fiber membrane module is discharged.

The DL can be carried out by one of the following methods:
a method of discharging compressed air introduced from the cleaning outlet (3) of the hollow fiber membrane module (100) via a compressed air valve for draining treatment (V7) and the cleaning waste liquid remaining at the interior portion of the hollow fiber membrane module out of the system via the inlet (1) and the cleaning waste liquid drain valve (V4); and a method of discharging the cleaning waste liquid remaining at the interior portion of hollow fiber membrane module out of the system via the cleaning waste liquid drain valve (V4) by the weight of the cleaning waste liquid.

### <Air-Scrubbing Treatment (AS)>

In AS, compressed air is introduced from the inlet and discharged from the cleaning outlet, and the hollow fiber membranes are shaken by air (bubbles) passing through the exterior side of the hollow fiber membranes.

In the AS, the air compressed by the compressor (500) is introduced into the hollow fiber membrane module (100) from the inlet (1) via the AS valve (V6), passed through the exterior space of the hollow membranes, and discharged out of the system via the cleaning outlet (3) and the cleaning waste liquid discharge valve (V5).

### <Backwashing-Air Scrubbing Simultaneous Cleaning (ASBW)>

In ASBW, the above BW and AS are carried out simultaneously. Specifically, filtered water within the filtered water tank (400) is introduced into the hollow fiber membrane module (100) from the filtered water port (2) through the backwashing valve (V3) and discharged out of the system via the inlet (1) and the cleaning waste liquid drain valve (V4), while compressed air from the compressor (500) is introduced into the hollow fiber membrane module (100) from the inlet (1) via the AS valve (V6) and discharged out of the system via the cleaning outlet (3) and the cleaning waste liquid discharge valve (V5).

### <Flashing-Air Scrubbing Simultaneous Cleaning (ASFL)>

In ASFL, the above FL and AS are carried out simultaneously. Specifically, a liquid to be treated from within the raw water tank (300) is introduced into the hollow fiber membrane module (100) from the inlet (1) via the raw water feed valve (V1) and then discharged out of the system via the cleaning outlet (3) and the cleaning waste liquid discharge valve (V5), while compressed air from the compressor (500) is introduced into the hollow fiber membrane module (100) from the inlet (1) via the AS valve (V6) and discharged out of the system via the cleaning outlet (3) and cleaning waste liquid discharge valve (V5).

### <<Discharging Step>>

In the method for cleaning a hollow fiber membrane module of the present invention, a discharging step of discharging a cleaning waste liquid remaining at the interior portion of the hollow fiber membrane module may be carried out after the cleaning step.

When the filtration system (1000) in FIG. 2 is used, the discharging step can be carried out by discharging compressed air introduced from the cleaning outlet (3) of the hollow fiber membrane module (100) via the compressed air valve for draining treatment (V7) together with the cleaning liquid remaining at the interior portion of the hollow fiber membrane module out of the system via the inlet (1) and the cleaning waste liquid drain valve (V4).

### <<Hollow Fiber Membrane Module>>

According to another viewpoint of the present invention, a hollow fiber membrane module in which, when a filtration operation using porous hollow fiber membranes is accompanied by a cleaning step, cleaning efficiency is excellent, deterioration of filtration performance over time is suppressed, and lifespan of the hollow fiber membranes and the hollow fiber membrane module comprising the same are not impaired is provided.

Such a hollow fiber membrane module is

a hollow fiber membrane module comprising
a hollow fiber membrane bundle composed of a plurality of hollow fiber membranes;
a housing in which the hollow fiber membrane bundle is housed; and
an adhesive fixing portion by which both ends of the hollow fiber membrane bundle are adhesively fixed to the housing, wherein
the hollow fiber membranes are microfiltration (MF) membranes or ultrafiltration membranes (UF) membranes,
the adhesive fixing portion comprises
   a first adhesive fixing layer for adhesively fixing the hollow fiber membranes to each other and the hollow fiber membrane bundle to the housing via a resin material at one end of the hollow fiber membranes; and
   a second adhesive fixing layer for adhesively fixing the hollow fiber membranes to each other and the hollow fiber membrane bundle to the housing via a resin material at the other end of the hollow fiber membranes,
the hollow fiber membrane module comprises
   an inlet for communicating between an exterior portion of the hollow fiber membrane module and a space outside the hollow fiber membranes;
   a filtered water port for communicating between an exterior portion of the hollow fiber membrane module and spaces inside the hollow fiber membranes; and
   a cleaning outlet for communicating between an exterior portion of the hollow fiber membrane module and a space outside the hollow fiber membranes, and
all of the following conditions (A), (B), and (C) are satisfied:
   (A) a packing rate of the hollow fiber membranes, which is expressed as a ratio of a total cross-sectional area of the hollow fiber membranes to an internal cross-sectional area of the housing, is 38% or less;
   (B) an outer diameter of the hollow fiber membranes is 1.1 mm or less; and
   (C) a total membrane area of the hollow fiber membranes is 70 m² or more.

The effective length of the hollow fiber membranes in the hollow fiber membrane module is preferably 1.6 m or more.

The adhesive fixing portion of the hollow fiber membrane module preferably does not have a restricting member for restricting the arrangement of the hollow fiber membranes.

Further, it is preferable that the hollow portions of the hollow fiber membranes in the first adhesive fixing layer be open and the hollow portions of the hollow fiber membranes in second adhesive fixing layer be sealed.

Furthermore, it is preferable that the second adhesive fixing layer have a hole penetrating the second adhesive fixing layer.

For other aspects of the above hollow fiber membrane module, the above description can be used as a description of the hollow fiber membrane module to which the cleaning method of the present invention is applied.

### <<Filtration Method>>

According to yet another viewpoint of the present invention, a filtration method using the above hollow fiber membrane module is provided.

The filtration method is
a filtration method for filtering raw water using the above hollow fiber membrane module, wherein
the filtration method comprises
   a filtration step of filtering by external pressures filtration to cause the raw water to pass through the hollow fiber membranes to obtain filtered water; and
   a cleaning step which is carried out after the filtration step,
the cleaning step comprises in the following order:
a first cleaning step of carrying out reverse-flow cleaning or flushing and a second cleaning step, and
in the second cleaning step,
   reverse-flow cleaning, in which the filtered water from an interior side to an exterior side of the hollow fiber membranes, or flushing, in which raw water is introduced from the inlet and discharged from the cleaning outlet; and
   air scrubbing, in which raw water containing air bubbles is introduced from the inlet and discharged from the cleaning outlet and the hollow fiber membranes are shaken by the air bubbles, are carried out in combination, whereby reverse-flow cleaning-air scrubbing simultaneous cleaning or flushing-air scrubbing simultaneous cleaning is carried out to clean an exterior surface of the hollow fiber membranes. In this filtration method, the first cleaning step may not be carried out in the cleaning step, and a high cleaning effect can be obtained without carrying out the first cleaning step.

The above filtration method may further comprise a third cleaning step after the first cleaning step and the second cleaning step.

The third cleaning step may be a step of carrying out at least one treatment of the following (C1) and (C2):
(C1) a flushing treatment by passing water through a raw water side of the hollow fiber membranes; and
(C2) a reverse-flow cleaning treatment by passing water from a filtered water side to a raw water side of the hollow fiber membranes.

The above filtration method preferably comprises a discharging step of discharging a cleaning waste liquid from the exterior side and the hollow portions of the hollow fiber membranes through the inlet or the cleaning outlet after the cleaning step.

The discharging step is preferably a step of introducing compressed air into the inlet or the cleaning outlet to forcibly discharge the cleaning waste liquid.

The average turbidity of the raw water filtered by the above hollow fiber membrane module is preferably 10 degrees or more, whereby the performance of the hollow fiber membrane module can be suitably demonstrated.

### EXAMPLES

### <<Hollow Fiber Membrane Module>>

In the following Examples and Comparative Examples, an external pressure filtration hollow fiber membrane module (total membrane area: 50 m²) produced by bundling 6,600 hollow fiber filtration membranes (ultrafiltration membrane, made of polyvinylidene fluoride (PVDF), outer diameter: 1.2 mm, inner diameter: 0.7 mm, length: 2 m, average pore size of membrane: 0.08 μm) manufactured by Asahi Kasei Corporation and housing the bundle in a casing (length: 2 m, diameter: 6 in., cylindrical shape) made of ABS was used.

### <<Test Method>>

River surface water containing suspended solids (SS) as the suspended component was used as raw water. The amount of SS in the river surface water was 0.024 g/L, and the TOC (total organic carbon content) was 0.003 g/L.

Filtration operation was carried out for 30 min by a constant flow rate external pressure dead-end filtration method in which raw water was supplied to the hollow fiber membrane exterior space of the hollow fiber membrane module at a daily flow rate per m² of membrane area of 2.4 m³/m²/day (=5,000 L/hr) without allowing the raw water to flow to the discharging water side.

Predetermined cleaning for each Example and Comparative Example was subsequently carried out.

A cycle comprising the above 30-min filtration operation and predetermined cleaning was repeated for 12 months of operation.

After 12 months, transmembrane pressure difference was measured and a leak test was carried out.

A mixed aqueous solution of sodium hypochlorite and sodium hydroxide and an aqueous citric acid solution were sequentially used to chemically clean the hollow fiber membrane module after 12 months of operation. The permeable water volume was then measured and compared to the permeable water volume of an unused hollow fiber membrane module.

In Comparative Examples 4 and 5, since stable operation for 12 months could not be carried out, the operation was stopped when stable operation was no longer possible, and the transmembrane pressure difference was measured at that time.

For the Examples and Comparative Examples in which the first cleaning step was carried out, the amount of SS removed by the first cleaning step during the first cleaning after the start of operation was measured, and the removal rate (% by mass) relative to the amount of SS introduced was calculated. The amount of SS introduced into the hollow fiber membrane module from the raw water during a 30-min filtration operation was 60 g (5,000 L/hr×0.5 hr×0.024 g/L=60 g).

### Example A1

Example A1 was subjected to cleaning by a method in which
a reverse-flow cleaning treatment with filtered water was carried out as the first cleaning step;
a reverse-flow cleaning treatment with filtered water and an air scrubbing treatment with air were subsequently carried out simultaneously as the second cleaning step; and
a flushing treatment with raw water was then carried out as the third cleaning step. The cleaning conditions of each step are as follows.

<First Cleaning Step>
Reverse-flow cleaning treatment: a treatment of passing filtered water from the filtered water side to the raw water side at a flow rate of 2,000 L/hr
First cleaning step execution time: 30 s

<Second Cleaning Step>
Reverse-flow cleaning treatment: a treatment of passing filtered water from the filtered water side to the raw water side at a flow rate of 2,000 L/hr
Air scrubbing: a treatment of passing air through the raw water side at a flow rate of 5 Nm³/hr
Second cleaning step execution time: 1 min

<Third Cleaning Step>
Flushing treatment: a treatment of passing raw water through the raw water side at a flow rate of 3 m³/hr
Third cleaning step execution time: 1 min

In the first cleaning step of Example A1, 50% by volume in module capacity (hold-up amount) of the water present in the hollow fiber membrane module before cleaning was replaced by filtered water.

### Example A2

Example A2 was subjected to cleaning by a method in which flushing with raw water was carried out as the first cleaning step, followed by the second cleaning step and the third cleaning step under the same conditions as in Example A1. The cleaning conditions of the first cleaning step are as follows.

<First Cleaning Step>
Flushing treatment: a treatment of passing raw water through the raw water side at a flow rate of 3,000 L/hr
First cleaning step execution time: 30 s

In the first cleaning step of Example A2, 70% by volume in module capacity (hold-up amount) of the water present in the hollow fiber membrane module before cleaning was replaced by raw water.

### Example A3

Example A3 was subjected to cleaning by a method in which a draining treatment with air was carried for 30 s as the first cleaning step, followed by the second cleaning step and the third cleaning step under the same conditions as in Example A1. The cleaning conditions of the first cleaning step are as follows.

<Suspended Component Removal Step>

Draining treatment: a treatment of discharging 50% by volume in module capacity (hold-up amount) of the water in the hollow fiber membrane module

### Example A4

Example A4 was subjected to cleaning by a method in which a reverse-flow cleaning treatment with filtered water was carried out as the first cleaning step and an air scrubbing treatment with air was subsequently carried out as the second cleaning step, followed by the third cleaning step under the same conditions as in Example A1. The cleaning conditions of the first cleaning step and the second cleaning step are as follows.

<First Cleaning Step>
Reverse-flow cleaning treatment: a treatment of passing filtered water from the filtered water side to the raw water side at a flow rate of 2,000 L/hr
First cleaning step execution time: 30 s

<Second Cleaning Step>
Air scrubbing treatment: a treatment of passing air through the raw water side at a flow rate of 5 Nm³/hr
Second cleaning step execution time: 1 min

In the first cleaning step of Example A4, 50% by volume in module capacity (hold-up amount) of the water present in the hollow fiber membrane module before cleaning was replaced by filtered water.

### Example A5

Example A5 was subjected to cleaning by a method in which a reverse-flow cleaning with filtered water was carried out as the first cleaning step and a flushing treatment with raw water and an air scrubbing treatment with air were subsequently carried out simultaneously as the second cleaning step, followed by the third cleaning step under the same conditions as in Example A1. The cleaning conditions of the first cleaning step and the second cleaning step are as follows.

<First Cleaning Step>
Reverse-flow cleaning treatment: a treatment of passing filtered water from the filtered water side to the raw water side at a flow rate of 2,000 L/hr
First cleaning step execution time: 30 s

<Second Cleaning Step>
Raw water flushing treatment: a treatment of passing raw water through the raw water side at a flow rate of 3,000 L/hr
Air scrubbing treatment: a treatment of passing air through the raw water side at a flow rate of 5 Nm³/hr
Second cleaning step execution time: 1 min

In the first cleaning step of Example A5, 50% by volume in module capacity (hold-up amount) of the water present in the hollow fiber membrane module before cleaning was replaced by filtered water.

### Comparative Example A1

Except that the conditions of the first cleaning step and the second cleaning step were each changed to the following, cleaning was carried out in Comparative Example A1 under the same conditions as in Example A2. The cleaning conditions of the first cleaning step and the second cleaning step are as follows.

<First Cleaning Step>
Flushing treatment: a treatment of passing raw water through the raw water side at a flow rate of 3,000 L/hr
First cleaning step execution time: 10 s

<Second Cleaning Step>
Reverse-flow cleaning treatment: a treatment of passing filtered water from the filtered water side to the raw water side at a flow rate of 2,000 L/hr
Air scrubbing: a treatment of passing air through the raw water side at a flow rate of 5 Nm³/hr
Second cleaning step execution time: 1 min

In the first cleaning step of Comparative Example A1, 30% by volume in module capacity (hold-up amount) of the water present in the hollow fiber membrane module before cleaning was replaced by raw water.

### Comparative Example A2

Except that the conditions of the first cleaning step and the second cleaning step were each changed to the following, cleaning was carried out in Comparative Example A2 under the same conditions as in Example A2. The cleaning conditions of the first cleaning step and the second cleaning step are as follows.

<First Cleaning Step>
Flushing treatment: a treatment of passing raw water through the raw water side at a flow rate of 3,000 L/hr
First cleaning time execution time: 15 s

<Second Cleaning Step>
Reverse-flow cleaning treatment: a treatment of passing filtered water from the filtered water side to the raw water side at a flow rate of 2,000 L/hr
Air scrubbing treatment: a treatment of passing air through the raw water side at a flow rate of 5 Nm³/hr
Second cleaning time execution time: 1 min

In the first cleaning step of Comparative Example A2, 40% by volume in module capacity (hold-up amount) of the water present in the hollow fiber membrane module before cleaning was replaced by raw water.

### Comparative Example A3

Comparative Example A3 was subjected to cleaning by a method in which
the first cleaning step was not carried out;
an air scrubbing treatment with air was carried out as the second cleaning step; and
a flushing treatment with raw water was then carried out as the third cleaning step. The cleaning conditions of each step are as follows.

<Second Cleaning Step>
Air scrubbing treatment: a treatment of passing air through the raw water side at a flow rate of 5 Nm³/hr
Second cleaning step execution time: 1 min

<Third Cleaning Step>
Flushing treatment: a treatment of passing raw water through the raw water side at a flow rate of 3 m³/hr
Third cleaning step execution time: 1 min

### Comparative Example A4

Comparative Example A4 was subjected to cleaning by a method in which the first cleaning step was not carried out and only the second cleaning step and the third cleaning step were carried out under the same conditions as in Example A1.

### Comparative Example A5

Comparative Example A5 was subjected to cleaning by a method in which the first cleaning step was not carried out and only the second cleaning step and the third cleaning step were carried out under the same conditions as in Example A5.

### Comparative Example A6

Comparative Example A6 was subjected to cleaning by a method in which only the first cleaning step and the third cleaning step were carried out under the following conditions and the second cleaning step was not carried out. The cleaning conditions of the first cleaning step and the third cleaning step are as follows.

<First Cleaning Step>
Reverse-flow cleaning treatment: a treatment of passing filtered water from the filtered water side to the raw water side at a flow rate of 1,000 L/hr
First cleaning step execution time: 1 min

<Third Cleaning Step>
Flushing treatment: a treatment of passing raw water through the raw water side at a flow rate of 3 m³/hr
Third cleaning step execution time: 1 min

According to the reverse-flow cleaning treatment of the first cleaning step, 70% by volume in module capacity (hold-up amount) of the water present in the hollow fiber membrane module before cleaning was replaced by filtered water.

However, it should be noted that the second cleaning step prescribed in the present invention was not carried out in Comparative Example A6.

### Comparative Example A7

Comparative Example A7 was subjected to cleaning by a method in which only the first cleaning step was carried out under the following conditions and the second cleaning step and the third cleaning step were not carried out. The cleaning conditions of the first cleaning step are as follows.

<First Cleaning Step>
Flushing treatment: a treatment of passing raw water through the raw water side at a flow rate of 1.2 m³/hr
First cleaning step execution time: 1 min

According to the raw water flushing treatment of the first cleaning step, 80% by volume in module capacity (hold-up amount) of the water present in the hollow fiber membrane module before cleaning was replaced by raw water.

However, it should be noted that the second cleaning step prescribed in the present invention was not carried out in Comparative Example A7.

The results of the above Examples and Comparative Examples are shown in Table 1.

In Table 1, reverse-flow cleaning treatment is indicated as “BW”, flushing treatment with raw water as “FL”, draining treatment as “DL”, air scrubbing treatment as “AS”, simultaneous execution of backwashing and air scrubbing (backwashing-air scrubbing simultaneous cleaning) as “ASBW”, and simultaneous execution of flushing and air scrubbing (flushing-air scrubbing simultaneous cleaning) as “ASFL”.

TABLE 1

| | First cleaning step | | | | | | | | | | | | Recov- |
|---|---|---|---|---|---|---|---|---|---|---|---|---|---|
| | | | | Amount | | | | | | | | Transmem- | ery rate |
| | | | | of water | | | Second | | Third | | | brane | after |
| | | | | in module | SS re- | SS re- | cleaning step | | cleaning step | | Oper- | pressure | chem- |
| | Cleaning | Cleaning | | replaced/ | moval | moval | Cleaning | Cleaning | Cleaning | Cleaning | ation | after | ical |
| | method | time | | discharged | amount | rate | method | time | method | time | time | shutdown | cleaning |
| Example A1 | BW | 30 | s | 50% by | 5.4 g | 9% by | ASBW | 1 min | FL | 1 min | 12 | 1.90 kPa | 98% |
| | | | | volume | | weight | | | | | months | | |
| Example A2 | FL | 30 | s | 70% by | 7.2 g | 12% by | ASBW | 1 min | FL | 1 min | 12 | 1.95 kPa | 96% |
| | | | | volume | | weight | | | | | months | | |
| Example A3 | DL | 30 | s | 50% by | 13 g | 22% by | ASBW | 1 min | FL | 1 min | 12 | 1.93 kPa | 97% |
| | | | | volume | | weight | | | | | months | | |
| Example A4 | BW | 30 | s | 50% by | 4.2 g | 7% by | AS | 1 min | FL | 1 min | 12 | 1.90 kPa | 93% |
| | | | | volume | | weight | | | | | months | | |
| Example A5 | BW | 30 | s | 50% by | 5.4 g | 9% by | ASFL | 1 min | FL | 1 min | 12 | 1.90 kPa | 94% |
| | | | | volume | | weight | | | | | months | | |
| Comparative | FL | 10 | s | 30% by | 1.8 g | 3% by | ASBW | 1 min | FL | 1 min | 12 | 1.95 kPa | 80% |
| Example A1 | | | | volume | | weight | | | | | months | | |
| Comparative | FL | 15 | s | 40% by | 3.0 g | 5% by | ASBW | 1 min | FL | 1 min | 12 | 1.95 kPa | 82% |
| Example A2 | | | | volume | | weight | | | | | months | | |
| Comparative | — | — | | — | — | — | AS | 1 min | FL | 1 min | 12 | 2.20 kPa | 75% |
| Example A3 | | | | | | | | | | | months | | |
| Comparative | — | — | | — | — | — | ASBW | 1 min | FL | 1 min | 12 | 2.10 kPa | 85% |
| Example A4 | | | | | | | | | | | months | | |
| Comparative | — | — | | — | — | — | ASFL | 1 min | FL | 1 min | 12 | 2.10 kPa | 80% |
| Example A5 | | | | | | | | | | | months | | |
| Comparative | BW | 1 | min | 70% by | 7.2 g | 12% by | — | — | FL | 1 min | 4 | 2.10 kPa | — |
| Example A6 | | | | volume | | weight | | | | | months | | |
| Comparative | FL | 1 | min | 80% by | 8.4 g | 14% by | — | — | — | — | 2 | 2.10 kPa | — |

| | | | |
|---|---|---|---|
| Example A7 | volume | weight | months |

The following evaluation of the Examples and Comparative Examples was carried out according to the following methods.

### <Suspended Component Dischargeability Test>

In the suspended component dischargeability test, how much of the suspended component total (turbidity in raw water×filtrate amount) introduced into the hollow fiber membrane module in the filtration step was discharged in the cleaning step was examined.

For example, when the operation sequence of F (28.5 min)-ASBW (1 min)-FL (0.5 min) at raw water turbidity of 10 NTU, filtrate volume of 10 m³/hr, backwashing water volume of 10 m³/hr, and FL water volume of 10 m³/hr was run, if the average turbidity of the discharged water during ASBW was 200 NTU and the average turbidity of the discharged water during FL was 50 NTU, the suspended component dischargeability is calculated as follows.

[{(1×200×10)+(0.5×50×10)}/(28.5×10×10)]×100=79%

### <Abrasion Durability Test>

When hollow fiber membranes in a state of having a suspended component accumulated thereon is subjected to air scrubbing, the hollow fiber membranes may abrade against each other with the suspended component, clogging the pores of the hollow fiber membranes and reducing the permeable water volume. Therefore, an accelerated test of filtration operation comprising air scrubbing in the cleaning step was carried out to examine the retention rate of permeable water volume, which was used as an index of abrasion durability.

The raw water turbidity was set to 10 NTU and one cycle of the operation sequence of F (1 min)-ASBW (1 min)-FL (0.5 min) was set as an accelerated operation condition to calculate the retention rate of pure water permeable volume of the hollow fiber membrane module before and after 10,000 cycles of filtration operation.

### <Recovery Rate>

The recovery rate is an index indicating what percentage of the filtration FLUX (permeable water flow rate) set in one cycle can be secured as filtered water by subtracting the amount of filtered water consumed in the cleaning step from the amount of filtered water obtained in the filtration step.

For example, when one cycle of operation sequence is set to F (28.5 min)-ASBW (1 min)-FL (0.5 min), filtration FLUX to 10 m³/hr, and backwashing water volume to 8 m³/hr, the recovery rate is calculated as follows.

[{(28.5×10÷60)−(1×8÷60)}/(30×10÷60)]×100=92%

### Example B1: Reference Example

16,500 hollow fiber membranes (manufactured by Asahi Kasei Corporation) made of PVDF (polyvinylidene fluoride) were bundled at a length of 2.3 m and suspended vertically. The lower end faces were cut to align the surfaces. Mending tape was then attached to the entire periphery of the membrane bundle so that the circumference was 170 mm. 300 g of urethane resin was weighed with a mixing-discharging machine. The lower face of the membrane bundle was immersed in the urethane resin for 30 s and immediately removed. The membrane bundle was then left at room temperature for 4 h to cure the urethane resin impregnated on the lower face of the membrane bundle, thereby sealing the hollow portions. The resulting bundle was inserted into a housing having a first tubular member (pipe inner diameter: 200 mm) for housing the hollow fiber membrane bundle and a second tubular member (pipe inner diameter: 218 mm) mounted therein a rectifying tube having an inner diameter of 216 mm.

The hollow fiber membranes used herein had an average pore size of 0.1 μm, an inner diameter of 0.6 mm, and an outer diameter of 0.95 mm.

Next, 40 columnar members (diameter: 11 mm) were inserted into planned through-hole formation positions at the end portion (first adhesive fixing layer) of the hollow fiber membrane bundle on the first tubular member side.

Next, a potting material was injected into the first tubular member and the second tubular member of the housing while the container for forming the adhesive fixing portion attached to the tube for introducing the potting material was fixed to both ends of the housing and rotated. A two-component thermosetting urethane resin (SA-6330A2/SA-6330B5 (trade name), manufactured by Sanyu Rec Co., Ltd.) was used as the potting material. When the curing reaction of the potting material progressed and fluidization stopped, the rotation of the centrifuge was stopped, the housing was removed, and the urethane resin was heated to 50° C. in an oven to cure.

The membrane bundle end portion on the second tubular member side of the housing was then cut off to open the hollow portions of the hollow fiber membranes on the side which was sealed in the step before adhesion. The columnar members were removed from the first adhesive fixing portion on the first tubular member side to form a plurality of through-holes. Note that, the effective membrane length of the present hollow fiber membrane module was 2.0 m.

The packing rate of the manufactured hollow fiber membrane module was 37.2%.

The D hardness measured according to MS K7215 for the adhesive fixing portion on the end faces of the manufactured hollow fiber membrane module was 55D. The D hardness of the adhesive fixing portion was measured with a load-holding time of 10 s, and the hardness value was the average value of 5 points randomly selected from the adhesive fixing portion on an end face.

The hollow fiber membrane module obtained above was attached to the filtration system shown in FIG. 2 with the side where the hollow portions of the hollow fiber membranes are open facing up, and a suspended component dischargeability test and an abrasion durability test were carried out.

The suspended component dischargeability was examined by an operation under the following settings.
Operation sequence: F (28.5 min)-ASBW (1 min)-FL (0.5 min), set in this order
Raw water turbidity: 10 NTU
Filtration FLUX: 100 LMH
Backwashing FLUX: 80 LMH
FL flow rate: 3 m³/hr

As a result, the average turbidity of the discharged water during ASBW was 250 NTU, and the average turbidity of the discharged water during FL was 180 NTU. Further, the mass ratio (suspended component removal rate) of the removed suspended component to the suspended component introduced into the module was 80% by mass.

The abrasion durability was examined by an operation under the following settings.
Operation sequence: F (1 min)-ASBW (1 min)-FL (0.5 min), set in this order
Raw water turbidity: 120 NTU
Filtration FLUX: 100 LMH
Backwashing FLUX: 80 LMH
FL flow rate: 3 m³/hr

The pure water permeable volume of the hollow fiber membrane module after 10,000 cycles of operation under the above conditions was compared with the initial pure water permeable volume to determine the permeable water volume retention rate, which was 80%.

Note that, in Table 2, “footprint” is, “SS removal rate” is a value indicating a removal rate (% by mass) of the measured amount of SS removed in the first cleaning step during the first cleaning after start of operation relative to the amount of SS introduced. Further, the “recovery rate” is a value indicating a ratio of the amount of liquid that can be secured as filtered water with respect to the filtration FLUX in units of % by mass.

### Examples B2 to B8 and Comparative Examples B1 to B7

Membrane modules were produced in the same manner as in Example B1, except that the specifications and testing conditions of the membrane modules were as shown in Table 2. The suspended component dischargeability test and the abrasion durability test were carried out.

Note that, Examples B2 and B3 are reference examples.

The results are summarized in Table 2.

In the above Examples and Comparative Examples, sand-filtered backwashing wastewater from a water purification plant that was diluted and adjusted to the turbidity shown in Table 2 was used.

TABLE 2

| | | Example B1 | Example B2 | Example B3 | Example B4 |
|---|---|---|---|---|---|
| Hollow fiber membrane | | | | | |
| Fiber outer diameter (mm) | | 0.95 | 0.95 | 0.95 | 0.95 |
| Fiber inner diameter (mm) | | 0.6 | 0.6 | 0.6 | 0.6 |
| Number of fibers | | 16500 | 13500 | 16500 | 16500 |
| Membrane area (m²) | | 98 | 81 | 98 | 98 |
| Effective length (m) | | 2.0 | 2.0 | 2.0 | 2.0 |
| Module, first tubular member | | | | | |
| Pipe inner diameter (mm) | | 200 | 182 | 200 | 200 |
| Hollow fiber membrane packing rate (%) | | 37 | 37 | 37 | 37 |
| Footprint (m²/m²) | | 3135 | 3097 | 3135 | 3135 |
| Operation sequence | | F-ASBW-FL | F-ASBW-FL | F-ASFL | F-BW-ASBW-FL |
| Operating conditions | | | | | |
| F | Time [min] | | | | |
| | Suspended component | 28.5 | 28.5 | 28.5 | 28.5 |
| | dischargeability test | | | | |
| | Abrasion durability test | 1.0 | 1.0 | 1.0 | 1.0 |
| | Flux [LMH] | 100 | 100 | 100 | 100 |
| BW | Time [min] | — | — | — | 0.5 |
| | BW Flux [LMH] | — | — | — | 80 |
| FL | Time [min] | — | — | — | — |
| | Flow rate [m³/h] | — | — | — | — |
| ASBW | Time [min] | 1.0 | 1.0 | — | 1.0 |
| | BW Flux [LMH] | 80 | 80 | — | 80 |
| | AS flow rate [Nm³/h] | 7 | 6 | — | 7 |
| ASFL | Time [min] | — | — | 1.5 | — |
| | Flow rate [m³/h] | — | — | 8.0 | — |
| | AS flow rate [Nm³/h] | — | — | 7 | — |
| FL | Time [min] | 0.5 | 0.5 | — | 0.5 |
| | Flow rate [m³/h] | 3 | 3 | — | 3 |
| Filtrate turbidity [NTU] | | | | | |
| | Suspended component | 10 | 10 | 10 | 10 |
| | dischargeability test | | | | |
| | Abrasion durability test | 120 | 120 | 120 | 120 |
| Evaluation results | | | | | |
| First cleaning step | | | | | |
| | Amount of water | — | — | — | 50% by volume |
| | replaced/discharged | | | | or greater |
| | SS removal rate | — | — | — | 7% or greater |

| | | | | |
|---|---|---|---|---|
| Suspended component removal rate | 80 | 85 | 80 | 80 |
| (% by mass) | | | | |
| Permeable water volume retention rate | 80 | 80 | 80 | 90 |
| after abrasion | | | | |
| Recovery rate (% by mass) | 92 | 92 | 95 | 92 |

| | | Example B5 | Example B6 | Example B7 | Example B8 |
|---|---|---|---|---|---|
| Hollow fiber membrane | | | | | |
| Fiber outer diameter (mm) | | 0.95 | 0.95 | 1.05 | 0.85 |
| Fiber inner diameter (mm) | | 0.6 | 0.6 | 0.7 | 0.7 |
| Number of fibers | | 16500 | 16500 | 11000 | 18000 |
| Membrane area (m²) | | 98 | 84 | 73 | 96 |
| Effective length (m) | | 2.0 | 1.7 | 2.0 | 2.0 |
| Module, first tubular member | | | | | |
| Pipe inner diameter (mm) | | 200 | 200 | 182 | 200 |
| Hollow fiber membrane packing rate (%) | | 37 | 37 | 37 | 33 |
| Footprint (m²/m²) | | 3135 | 2665 | 2790 | 3060 |
| Operation sequence | | F-FL-ASFL | F-BW-ASFL | F-BW-ASFL | F-BW-ASFL |
| Operating conditions | | | | | |
| F | Time [min] | | | | |
| | Suspended component | 28.5 | 28.5 | 28.5 | 28.5 |
| | dischargeability test | | | | |
| | Abrasion durability test | 1.0 | 1.0 | 1.0 | 1.0 |
| | Flux [LMH] | 100 | 100 | 100 | 100 |
| BW | Time [min] | — | 0.5 | 0.5 | 0.5 |
| | BW Flux [LMH] | — | 80 | 80 | 80 |
| FL | Time [min] | 0.5 | — | — | — |
| | Flow rate [m³/h] | 8 | — | — | — |
| ASBW | Time [min] | — | — | — | — |
| | BW Flux [LMH] | — | — | — | — |
| | AS flow rate [Nm³/h] | — | — | — | — |
| ASFL | Time [min] | 1.0 | 1.0 | 1.0 | 1.0 |
| | Flow rate [m³/h] | 8.0 | 8.0 | 8.0 | 8.0 |
| | AS flow rate [Nm³/h] | 7 | 7 | 6 | 6 |
| FL | Time [min] | — | — | — | — |
| | Flow rate [m³/h] | — | — | — | — |
| Filtrate turbidity [NTU] | | | | | |
| | Suspended component | 10 | 10 | 10 | 10 |
| | dischargeability test | | | | |
| | Abrasion durability test | 120 | 120 | 120 | 120 |
| Evaluation results | | | | | |
| First cleaning step | | | | | |
| | Amount of water | 50% by | 50% by | 50% by | 50% by |
| | replaced/discharged | volume or | volume or | volume or | volume or |
| | | greater | greater | greater | greater |
| | SS removal rate | 7% or greater | 7% or greater | 7% or greater | 7% or greater |

| | | | | |
|---|---|---|---|---|
| Suspended component removal rate | 80 | 85 | 85 | 85 |
| (% by mass) | | | | |
| Permeable water volume retention rate | 90 | 90 | 90 | 90 |
| after abrasion | | | | |
| Recovery rate (% by mass) | 95 | 94 | 94 | 94 |

| | | Comparative | Comparative | Comparative | Comparative |
|---|---|---|---|---|---|
| | | Example B1 | Example B2 | Example B3 | Example B4 |
| Hollow fiber membrane | | | | | |
| Fiber outer diameter (mm) | | 0.95 | 1.22 | 1.10 | 0.95 |
| Fiber inner diameter (mm) | | 0.6 | 0.8 | 0.7 | 0.8 |
| Number of fibers | | 18500 | 10000 | 13000 | 11000 |
| Membrane area (m²) | | 110 | 77 | 90 | 66 |
| Effective length (m) | | 2.0 | 2.0 | 2.0 | 2.0 |
| Module, first tubular member | | | | | |
| Pipe inner diameter (mm) | | 200 | 200 | 200 | 200 |
| Hollow fiber membrane packing rate (%) | | 42 | 37 | 39 | 42 |
| Footprint (m²/m²) | | 3515 | 2440 | 2860 | 3525 |
| Operation sequence | | F-ASBW-FL | F-ASBW-FL | F-ASBW-FL | F-BW-ASBW-FL |
| Operating conditions | | | | | |
| F | Time [min] | | | | |
| | Suspended component | 28.5 | 28.5 | 28.5 | 28.5 |
| | dischargeability test | | | | |
| | Abrasion durability test | 1.0 | 1.0 | 1.0 | 1.0 |
| | Flux [LMH] | 100 | 100 | 100 | 100 |
| BW | Time [min] | — | — | — | 0.5 |
| | BW Flux [LMH] | — | — | — | 80 |
| FL | Time [min] | — | — | — | — |
| | Flow rate [m³/h] | — | — | — | — |
| ASBW | Time [min] | 1,0 | 1.0 | 1.0 | 1.0 |
| | BW Flux [LMH] | 80 | 80 | 80 | 80 |
| | AS flow rate [Nm³/h] | 7 | 7 | 7 | 7 |
| ASFL | Time [min] | — | — | — | — |
| | Flow rate [m³/h] | — | — | — | — |
| | AS flow rate [Nm³/h] | — | — | — | — |
| FL | Time [min] | 0.5 | 0.5 | 0.5 | 0.5 |
| | Flow rate [m³/h] | 3 | 3 | 3 | 3 |
| Filtrate turbidity [NTU] | | | | | |
| | Suspended component | 10 | 10 | 10 | 10 |
| | dischargeability test | | | | |
| | Abrasion durability test | 120 | 120 | 120 | 120 |
| Evaluation results | | | | | |
| First cleaning step | | | | | |
| | Amount of water | — | — | — | 50% by volume |
| | replaced/discharged | | | | or greater |
| | SS removal rate | — | — | — | 7% or greater |

| | | | | |
|---|---|---|---|---|
| Suspended component removal rate | 65 | 80 | 70 | 80 |
| (% by mass) | | | | |
| Permeable water volume retention rate | 80 | 70 | 70 | 80 |
| after abrasion | | | | |
| Recovery rate (% by mass) | 92 | 92 | 92 | 92 |

| | | Comparative | Comparative | Comparative |
|---|---|---|---|---|
| | | Example B5 | Example B6 | Example B7 |
| Hollow fiber membrane | | | | |
| Fiber inner diameter (mm) | | 1.20 | 0.95 | 1.2 |
| Fiber outer diameter (mm) | | 0.8 | 0.8 | 0.8 |
| Number of fibers | | 13000 | 11000 | 13000 |
| Membrane area (m²) | | 216 | 182 | 230 |
| Effective length (m) | | 2.0 | 2.0 | 2.0 |
| Module, first tubular member | | | | |
| Pipe inner diameter (mm) | | 200 | 200 | 200 |
| Hollow fiber membrane packing rate (%) | | 40 | 30 | 35 |
| Footprint (m²/m²) | | 2675 | 2524 | 2359 |
| Operation sequence | | F-BW-ASBW-FL | F-BW-ASBW-FL | F-BW-ASBW-FL |
| Operating conditions | | | | |
| F | Time [min] | | | |
| | Suspended component | 28.5 | 28.5 | 28.5 |
| | dischargeability test | | | |
| | Abrasion durability test | 1.0 | 1.0 | 1.0 |
| | Flux [LMH] | 100 | 100 | 100 |
| BW | Time [min] | 0.5 | 0.5 | 0.5 |
| | BW Flux [LMH] | 80 | 80 | 80 |
| FL | Time [min] | — | — | — |
| | Flow rate [m³/h] | — | — | — |
| ASBW | Time [min] | 1.0 | 1.0 | 1.0 |
| | BW Flux [LMH] | 80 | 80 | 80 |
| | AS flow rate [Nm³/h] | 7 | 7 | 7 |
| ASFL | Time [min] | — | — | — |
| | Flow rate [m³/h] | — | — | — |
| | AS flow rate [Nm³/h] | — | — | — |
| FL | Time [min] | 0.5 | 0.5 | 0.5 |
| | Flow rate [m³/h] | 3 | 3 | 3 |
| Filtrate turbidity [NTU] | | | | |
| | Suspended component | 10 | 10 | 10 |
| | dischargeability test | | | |
| | Abrasion durability test | 120 | 120 | 120 |
| Evaluation results | | | | |
| First cleaning step | | | | |
| | Amount of water | 50% by volume | 50% by volume | 50% by volume |
| | replaced/discharged | or greater | or greater | or greater |
| | SS removal rate | 7% or greater | 7% or greater | 7% or greater |

| | | | |
|---|---|---|---|
| Suspended component removal rate | 60 | 80 | 80 |
| (%b y mass) | | | |
| Permeable water volume retention rate | 60 | 80 | 80 |
| after abrasion | | | |
| Recovery rate (% by mass) | 92 | 92 | 92 |

### REFERENCE SIGNS LIST

1 inlet
2 filtered water port
3 cleaning outlet
10 hollow fiber membrane bundle
11 hollow fiber membrane
20 adhesive fixing portion
21 first adhesive fixing layer
22 second adhesive fixing layer
30 housing
31 first tubular member
32A second tubular member A
32B second tubular member B
41 interior space of hollow fiber
42 exterior space of hollow fiber
50 rectifying tube
100 hollow fiber membrane module
200 raw liquid tank
210 strainer
300 raw water tank
400 filtered water tank
500 compressor
1000 filtration system
V1 raw water feed valve
V2 filtered water feed valve
V3 backwashing valve
V4 cleaning waste liquid drain valve
V5 cleaning waste liquid discharge valve
V6 air scrubbing valve
V7 compressed air valve for draining treatment

1. A hollow fiber membrane module comprising
a hollow fiber membrane bundle composed of a plurality of hollow fiber membranes;
a housing in which the hollow fiber membrane bundle is housed; and
an adhesive fixing portion by which both ends of the hollow fiber membrane bundle are adhesively fixed to the housing, wherein
the hollow fiber membranes are microfiltration (MF) membranes or ultrafiltration (UF) membranes,
the adhesive fixing portion comprises
a first adhesive fixing layer for adhesively fixing hollow fiber membranes to each other and the hollow fiber membrane bundle to an interior wall of the housing via a resin material at one end of the hollow fiber membranes; and
a second adhesive fixing layer for adhesively fixing the hollow fiber membranes to each other and the hollow fiber membrane bundle to an interior wall of the housing via a resin material at the other end of the hollow fiber membranes,
the hollow fiber membrane module comprises
an inlet for communicating between an exterior portion of the hollow fiber membrane module and a space outside the hollow fiber membranes;
a filtered water port for communicating between an exterior portion of the hollow fiber membrane module and spaces inside the hollow fiber membranes; and
a cleaning outlet for communicating between an exterior portion of the hollow fiber membrane module and a space outside the hollow fiber membranes, and
all of the following conditions (A), (B), and (C) are satisfied:
(A) a packing rate of the hollow fiber membranes, which is expressed as a ratio of a total cross-sectional area of the hollow fiber membranes to an internal cross-sectional area of the housing, is 38% or less;
(B) an outer diameter of the hollow fiber membranes is 1.1 mm or less; and
(C) a total membrane area of the hollow fiber membranes is 70 m² or more.

2. The hollow fiber membrane module according to claim 1, wherein an effective length of the hollow fiber membranes is 1.6 m or more.

3. The hollow fiber membrane module according to claim 1, wherein the adhesive fixing portion of the hollow fiber membrane module does not have a restricting member for restricting an arrangement of the hollow fiber membranes.

4. The hollow fiber membrane module according to claim 3, wherein
hollow portions of the hollow fiber membranes are open in the first adhesive fixing layer, and
hollow portions of the hollow fiber membranes are sealed at the second adhesive fixing layer.

5. The hollow fiber membrane module according to claim 1, wherein the second adhesive fixing layer has a hole penetrating the second adhesive fixing layer.

6. A filtration method, in which a filtrate is filtered using the hollow fiber membrane module according to claim 1, wherein
the filtration method comprises
filtering by external pressure filtration to cause the filtrate to pass through the hollow fiber membranes to obtain filtered water; and
cleaning which is carried out after the filtering, wherein
the cleaning is a method for cleaning a hollow fiber membrane module which comprises a hollow fiber membrane for filtering raw water containing a suspended component, comprising in the following order:
first cleaning of removing the suspended component accumulated on the hollow fiber membrane; and
second cleaning of carrying out an air scrubbing treatment by passing a gas through at least a raw water side of the hollow fiber membrane, wherein
with respect to a capacity of the hollow fiber membrane, 50% by volume or greater of water present in the hollow fiber membrane module before cleaning is removed in the first cleaning.

7. The filtration method according to claim 6, wherein the first cleaning includes carrying out at least one treatment of the following (A1) to (A3):
(A1) a reverse-flow cleaning treatment by passing water from a filtered water side to a raw water side of the hollow fiber membrane;
(A2) a flushing treatment by passing water through a raw water side of the hollow fiber membrane; and
(A3) a draining treatment by discharging a liquid within the hollow fiber membrane module.

8. The filtration method according to claim 6, wherein 7% by mass or greater of a suspended component accumulated in the hollow fiber membrane is removed in the first cleaning.

9. The filtration method according to claim 6, wherein the second cleaning includes carrying out any of the following (B1) to (B3):
(B1) carrying out only an air scrubbing treatment by passing a gas through a raw water side of the hollow fiber membrane;
(B2) simultaneously carrying out an air scrubbing treatment by passing a gas through a raw water side of the hollow fiber membrane and a reverse-flow cleaning treatment by passing water from a filtered water side to a raw water side of the hollow fiber membrane; and
(B3) simultaneously carrying out an air scrubbing treatment by passing a gas through a raw water side of the hollow fiber membrane and a flushing treatment by passing water through a raw water side of the hollow fiber membrane.

10. The filtration method according to claim 6, further comprising
third cleaning of discharging the suspended component to an exterior portion of the hollow fiber membrane module after the first cleaning and the second cleaning.

11. The filtration method according to claim 10, wherein the third cleaning includes carrying out at least one treatment of the following (C1) and (C2):
(C1) a flushing treatment by passing water through a raw water side of the hollow fiber membrane; and
(C2) a reverse-flow cleaning treatment by passing water from a filtered water side to a raw water side of the hollow fiber membrane.

12. A filtration method for filtering a filtrate using the hollow fiber membrane module according to claim 1, wherein
the filtration method comprises
filtering by external pressure filtration to cause the filtrate to pass through the hollow fiber membranes to obtain filtered water; and
cleaning which is carried out after the filtering,
the cleaning comprises in the following order:
first cleaning of carrying out reverse-flow cleaning or flushing and a second cleaning, and
in the second cleaning,
reverse-flow cleaning, in which the filtered water from an interior side to an exterior side of the hollow fiber membranes, or flushing, in which a filtrate is introduced from the inlet and discharged from the cleaning outlet; and
air scrubbing, in which a filtrate containing air bubbles is introduced from the inlet and discharged from the cleaning outlet and the hollow fiber membranes are shaken by the air bubbles, are carried out in combination, whereby reverse-flow cleaning-air scrubbing simultaneous cleaning or flushing-air scrubbing simultaneous cleaning is carried out to clean an exterior surface of the hollow fiber membranes.

13. The method for cleaning a hollow fiber membrane module according to claim 12, further comprising third cleaning after the first cleaning and the second cleaning, wherein the third cleaning includes carrying out at least one treatment of the following (C1) and (C2):
(C1) a flushing treatment by passing water through a raw water side of the hollow fiber membranes; and
(C2) a reverse-flow cleaning treatment by passing water from a filtered water side to a raw water side of the hollow fiber membranes.

14. The filtration method according to claim 12, comprising
discharging cleaning waste liquid outside the hollow fiber membranes and in hollow portions thereof from the inlet or the cleaning outlet after the cleaning.

15. The filtration method according to claim 14, wherein the discharging includes introducing compressed air into the inlet or the cleaning outlet to forcibly discharge the cleaning waste liquid.

16. The filtration method according to claim 12, wherein an average turbidity of the filtrate is 10 degrees or more.
